(19) United States
(12) Patent Application Publication
(10) Pub. No.: US 2017/0263337 A1
(43) Pub. Date: Sep. 14, 2017

(54) METHODS AND APPARATUS FOR ENHANCED NUCLEAR REACTIONS

(71) Applicants: PineSci Consulting, Avon Lake, OH (US); NASA Glenn Research Center, Cleveland, OH (US)

(72) Inventors: Vladimir Pines, Avon Lake, OH (US); Marianna Pines, Avon Lake, OH (US); Bruce Steinetz, Westlake, OH (US); Arnon Chait, Bay Village, OH (US); Gustave Fralick, Middleburg Heights, OH (US); Robert Hendricks, North Olmsted, OH (US); Paul Westmeyer, Woodbridge, VA (US)

(73) Assignees: PineSci Consulting, Avon Lake, OH (US); NASA Glenn Research Center, Cleveland, OH (US)

(21) Appl. No.: 15/064,649

(22) Filed: Mar. 9, 2016

(51) Int. Cl. G21B 3/00

(52) U.S. Cl. CPC G21B 3/006; G21Y 2002/50; G21Y 2002/20; G21Y 2002/201

(57) ABSTRACT

Nuclear fusion processes with enhanced rates may be realized by providing energetic electrons in an environment containing a suitable fuel gas, a liquid fuel source, a solid fuel source, a plasma fuel source, or any combination thereof. The fuel source may be deuterium, tritium, a combination thereof, or any fuel source capable of creating deeply screened and/or neutral nuclei when exposed to energetic electrons. Under proper conditions, at least some of the deeply screened and/or neutral nuclei fuse with other nuclei. Neutral versions of deuteron and/or triton nuclei may be created by bringing neutrons with certain energy levels (e.g., around 3 MeV, but optionally less or much less than 3 MeV) into interaction with other neutrons, forming neutral versions of deuterons and/or tritons. Such processes may be used for power generation, heat production, nuclear waste remediation, material creation, and/or medical isotope production, for example.

### STATEMENT OF FEDERAL RIGHTS

This invention was made with government support under Contract No. NNC14CA16C awarded by the National Aeronautics and Space Administration (NASA). The Government has certain rights in the invention.

### FIELD

The present invention generally relates to facilitating nuclear reactions, and more particularly, to enhanced nuclear reactions using deep screening and/or forced electron capture.

### BACKGROUND

Nuclear reactions have been used to produce power and to transmute material utilizing a variety of techniques, either through nuclear fusion or nuclear fission. Nuclear power, for instance, is typically produced from fission reactions in a nuclear fuel source. Fission-based nuclear power production is used in many nations worldwide, and material transformation in nuclear reactors is a particularly beneficial and important technique for various applications. Fission typically produces a large amount of power relative to the amount of fuel, making it a particularly attractive choice for powering certain massive systems that would consume a large and potentially mission-limiting amount of fossil fuel (e.g., aircraft carriers and nuclear submarines), as well as systems where fuel cannot readily be supplied and/or where weight is a significant concern (e.g., space vehicles and planetary explorers). The fuel of choice is typically uranium, which is the heaviest naturally occurring element, for conventional terrestrial nuclear reactors. However, other heavy elements may be used.

Fission power relies on uranium or other heavy metals as fuel, which are relatively rare (or in the case of plutonium, man-made), difficult to refine, radioactive, and expensive. Although nuclear fission is used worldwide as a source of energy, there are ongoing concerns regarding its safety, particularly from an environmental perspective and a security perspective due to the nuclear waste that it generates. Furthermore, when safety systems fail in fission reactors, a meltdown may occur, as happened in the reactors at Chernobyl and Fukushima. With advanced technology, the nuclear material may be weaponized for use in a nuclear weapon, or with much more primitive technology, the material may be used in a “dirty bomb.” As such, there are significant safety and security concerns pertaining to fission power and its byproducts.

High energy thermonuclear fusion, similar to the process that occurs in the sun and other stars, is being investigated as a promising future energy solution. However, while thermonuclear fusion has the potential to provide a tremendous amount of power, the technology to commercially produce this energy is not yet available, and is unlikely to be available for a long time. To achieve thermonuclear fusion, it is currently necessary to generate plasma of hydrogen isotopes with thermal energy above 10 KeV (10⁸ K) and provide confinement for the duration of time required by Lawson criteria. These are difficult problems to solve in terms of energy expenditure to both maintain and contain.

Magnetic Confinement Fusion (MCF) makes use of particular magnetic field configurations such as toroidal systems (e.g., tokamaks, stellarators, multipols, and the Astron), magnetic mirrors, theta pinch devices, etc., to confine and hold a low density, very hot plasma, which would operate as a thermonuclear furnace in steady state regime. Direct drive or indirect drive Internal Confinement Fusion (ICF) is another approach, which is based on dramatically scaling down a thermonuclear explosion that could be readily utilized for power production as a thermonuclear compression ignition engine. In direct drive ICF, radiation from powerful lasers is directly applied and compresses a fuel capsule (i.e., a deuterium and tritium mixture) to thermonuclear temperature. In indirect drive ICF, a fuel capsule is surrounded with a cylindrical hohlraum made from high-Z materials, and radiation of powerful lasers or ion beams are converted to X-ray radiation, which compresses a fuel capsule to thermonuclear temperature. However, ICF processes are very expensive, require large amounts of energy, and are not yet efficient power sources of practical value.

Due to the inherent practical problems with controlled thermonuclear fusion experiments, alternative methods for producing nuclear fusion reactions at temperatures significantly lower than the very high temperatures required for thermonuclear fusion are being investigated. Various neutron generators based on beam-to-target fusion of hydrogen isotopes (i.e., a deuterium and tritium mixture) at room temperature are used as relatively inexpensive neutron sources. These generators typically contain compact linear accelerators or glow discharge plasma devices, and trade high fuel density with significantly increased ion velocity to overcome the strong electrostatic repulsion between the fusing ions.

Muon-catalyzed fusion (μCF), for example, is another technique for producing fusion reactions in gaseous mixture of hydrogen isotopes (i.e., a deuterium and tritium mixture) at room temperature, that is, with kinetic energy much lower than that associated with thermonuclear fusion. μCF is only one technique for producing fusion reactions in gaseous mixture of hydrogen isotopes at room temperature, i.e., with kinetic energy much lower than that associated with thermonuclear fusion. Although μCF is a relatively well-understood mechanism, it suffers from problems of practicality. Present techniques for creating large numbers of muons require large amounts of energy, which are larger than the amounts of energy produced by μCF. This prevents μCF fusion from becoming a practical power source. In order to create useful room temperature μCF reactors, a more efficient muon source and or a way to increase the over process efficiency is required.

Thus, an improved way to transform and transmute materials and extract energy by nuclear reactions may be beneficial.

Nuclear reactions may also be used for medical isotope production, or may produce medical isotopes as a byproduct. Medical isotopes are a critical aspect of many modern medical diagnostic techniques and procedures. Techniques for radioisotope production include various neutron activation and creation mechanisms to produce an isotope of a specific decay chain, as well as techniques for separation of the desired isotope from the source materials and any ancillary products also produced as part of the activation/creation processes. Activation of a source is typically accomplished by neutron activation in a nuclear reactor, and also by using energetic photons, electrons, protons, alpha particles, and others from a variety of machines specifically designed to accelerate these particles. Targets in many configurations, both fluids and solids, are impacted, and as a consequence of these impacts, a fraction of the original target material is transmuted, whether isotopic or elemental. Chemical post-processing of targets after activation results in the isolation of the desired radioisotope.

Isotope-specific systems, and often more than one system for most isotopes, have been designed and redesigned as the machinery used in the production processes has improved. As medical research is an ever-changing field, the number of isotopes of interest varies, and in some cases, the development of a new isotope production technique influences the usage of that isotope in medical procedures. Various radioisotopes may be used to treat cancer and other medical conditions, provide diagnostic information about the functioning of various organs, and sterilize medical equipment, among other applications. Tables 1 and 2 below provide lists of isotopes, half-lives, and uses for conventionally produced reactor and cyclotron radioisotopes, respectively.

TABLE 1
REACTOR-PRODUCED RADIOISOTOPES

| ISOTOPE: | HALF-LIFE: | | APPLICATIONS: |
|---|---|---|---|
| ²¹³Bi | 46 | min | Used for targeted alpha therapy (TAT), especially |
| | | | cancers, due to its high energy (8.4 MeV) |
| ¹³⁷Cs | 30 | years | Used for low-intensity sterilization of blood |
| ⁵¹Cr | 28 | days | Used to label red blood cells and to quantify |
| | | | gastrointestinal protein loss |
| ⁶⁰Co | 5.27 | years | Formerly used for external beam radiotherapy, now |
| | | | almost universally used for sterilization |
| ¹⁶⁵Dy | 2 | hours | Used as an aggregated hydroxide for synovectomy |
| | | | treatment of arthritis |
| ¹⁶⁹Er | 9.4 | days | Used for relieving arthritis pain in synovial joints |
| ¹⁶⁶Ho | 26 | hours | Being developed for diagnosis and treatment of |
| | | | liver tumors |
| ¹²⁵I | 60 | days | Used in cancer brachytherapy (prostate and brain), |
| | | | used diagnostically to evaluate the filtration rate of |
| | | | kidneys and to diagnose deep vein thrombosis in |
| | | | the leg, and widely used in radioimmuno-assays to |
| | | | show the presence of hormones in tiny quantities |
| ¹³¹I | 8 | days | Widely used in treating thyroid cancer and in |
| | | | imaging the thyroid, as well as in diagnosis of |
| | | | abnormal liver function, renal (kidney) blood flow, |
| | | | and urinary tract obstruction; while a strong gamma |
| | | | emitter, this isotope is used for beta therapy |
| ¹⁹²Ir | 74 | days | Supplied in wire form for use as an internal |
| | | | radiotherapy source for cancer treatment (used then |
| | | | removed); beta emitter |
| ⁵⁹Fe | 46 | days | Used in studies of iron metabolism in the spleen |
| ²¹²Pb | 10.6 | hours | Used in TAT for cancers or alpha |
| | | | radioimmunotherapy, with decay products ²¹²Bi |
| | | | and ²¹²Po delivering the alpha particles; used |
| | | | especially for melanoma, breast cancer, and |
| | | | ovarian cancer |
| ¹⁷⁷Lu | 6.7 | days | Increasingly important as it emits just enough |
| | | | gamma radiation for imaging while the beta |
| | | | radiation does the therapy on small (e.g., |
| | | | endocrine) tumors; half-life is long enough to allow |
| | | | sophisticated preparation for use; usually produced |
| | | | by neutron activation of natural or enriched ¹⁷⁶Lu |
| | | | targets |
| ⁹⁹Mo* | 66 | hours | Used as the “parent” in a generator to produce |
| | | | ^{99m}Tc |
| ¹⁰³Pd | 17 | days | Used to make brachytherapy permanent implant |
| | | | seeds for early stage prostate cancer |
| ³²P | 14 | days | Used in the treatment of polycythemia vera (excess |
| | | | red blood cells); beta emitter |
| ⁴²K | 12 | hours | Used for the determination of exchangeable |
| | | | potassium in coronary blood flow |
| ¹⁸⁶Re | 3.8 | days | Used for pain relief in bone cancer; beta emitter |
| | | | with weak gamma for imaging |
| ¹⁸⁸Re | 17 | hours | Used to beta irradiate coronary arteries from an |
| | | | angioplasty balloon |
| ¹⁵³Sm | 47 | hours | Highly effective in relieving the pain of secondary |
| | | | cancers lodged in the bone, sold as Quadramet ™, |
| | | | and also very effective for prostate and breast |
| | | | cancer; beta emitter. |
| ⁷⁵Se | 120 | days | Used in the form of seleno-methionine to study the |
| | | | production of digestive enzymes |
| ²⁴Na | 15 | hours | Used for studies of electrolytes within the body |
| ⁸⁹Sr | 50 | days | Highly effective in reducing the pain of prostate |
| | | | and bone cancer; beta emitter |
| ^{99m}Tc* | 6 | hours | Used to image the skeleton and heart muscle in |
| | | | particular, but also for brain, thyroid, lungs |
| | | | (perfusion and ventilation), liver, spleen, kidney |
| | | | (structure and filtration rate), gall bladder, bone |
| | | | marrow, salivary and lacrimal glands, heart blood |
| | | | pool, infection, and numerous specialized medical |
| | | | studies; also produced from ⁹⁹Mo in a generator |
| ¹³³Xe | 5 | days | Used for pulmonary (lung) ventilation studies |
| ¹⁶⁹Yb | 32 | days | Used for cerebrospinal fluid studies in the brain |
| ¹⁷⁷Yb | 1.9 | hours | Progenitor of ¹⁷⁷Lu |
| ⁹⁰Y | 64 | hours | Used for cancer brachytherapy and as a silicate |
| | | | colloid for the relieving the pain of arthritis in |
| | | | larger synovial joints; pure beta emitter and of |
| | | | growing significance in therapy, especially for liver |
| | | | cancer |

TABLE 2
CYCLOTRON-PRODUCED RADIOISOTOPES

| ISOTOPE: | HALF-LIFE: | | APPLICATIONS: |
|---|---|---|---|
| ¹¹C, ¹³N, | Not provided | | Positron emitters used in PET for studying brain |
| ¹⁵O, ¹⁸F | | | physiology and pathology, and in particular, for |
| | | | localizing epileptic focus, and in dementia, for |
| | | | psychiatry and neuropharmacology studies; also have |
| | | | a significant role in cardiology; ¹⁸F in |
| | | | fluorodeoxyglucose (FDG) has become very |
| | | | important in the detection of cancers and the |
| | | | monitoring of progress in their treatment using PET |
| ⁵⁷Co | 272 | days | Used as a marker to estimate organ size and for in- |
| | | | vitro diagnostic kits |
| ⁶⁴Cu | 13 | hours | Used to study genetic diseases affecting copper |
| | | | metabolism, such as Wilson's and Menke's diseases, |
| | | | and for PET imaging of tumors and therapy |
| ⁶⁷Cu | 2.6 | days | Beta emitter, used in therapy |
| ¹⁸F | Not provided | | Also used as a tracer in the form of fluorothymidine |
| | | | (FLT), fluoromisonidazole (F-miso), and 18F- |
| | | | choline |
| ⁶⁷Ga | 78 | hours | Used for tumor imaging and localization of |
| | | | inflammatory lesions (infections) |
| ⁶⁸Ga | 68 | min | Positron emitter used in PET and PET-CT units; |
| | | | derived from ⁶⁸Ge in a generator |
| ⁶⁸Ge | 271 | days | Used as the “parent” in a generator to produce ⁶⁸Ga |
| ¹¹¹In | 2.8 | days | Used for specialized diagnostic studies, e.g., brain |
| | | | studies, infection, and colon transit studies |
| ¹²³I | 13 | hours | Increasingly used for diagnosis of thyroid function; a |
| | | | gamma emitter without the beta radiation of ¹³¹I |
| ¹²⁴I | Not provided | | Tracer |
| ^{81m}Kr | 13 | sec | Produced from ⁸²Rb (4.6 hours), ^{81m}Kr gas can yield |
| | | | functional images of pulmonary ventilation, e.g. in |
| | | | asthmatic patients, and for the early diagnosis of lung |
| | | | diseases and function |
| ⁸²Rb | 1.26 | min | Convenient PET agent in myocardial perfusion |
| | | | imaging |
| ⁸²Sr | 25 | days | Used as the “parent” in a generator to produce ⁸²Rb |
| ²⁰¹Tl | 73 | hours | Used for diagnosis of coronary artery disease other |
| | | | heart conditions such as heart muscle death and for |
| | | | location of low-grade lymphomas |

Radioisotopes of cesium, gold, and ruthenium are also used in brachytherapy.

The (*) designates the importance of ⁹⁹Mo and ⁹⁹mTc (metastable). ⁹⁹Mo, and its product ⁹⁹mTc, are arguably the most important conventional radioisotopes since ⁹⁹mTc is used in over 80% of diagnostic nuclear medical imaging. ⁹⁹Mo is by far the most used isotope and has been the focus of many competitive production techniques within the last decade.

Newer isotope research is adding different and more complex production techniques for ⁹⁹Mo. Similar situations exist for the roughly 40 isotopes currently in use at medical facilities around the world. Linear accelerator (LINAC) production is also being developed as a new technique.

However, of the hundreds, if not thousands, of isotopes that are known to exist or are theoretically possible, only dozens are conventionally available for use in modern medicine. This limits treatments to the specific characteristics of these isotopes. Also, many of these isotopes are in limited supply and/or are difficult to obtain. Furthermore, certain medical isotopes must be produced and rapidly delivered to a medical facility in order to be effective. For instance, ⁹⁹Mo, which is generally a byproduct of the fission of ²³⁵U in nuclear reactors, has a half-life of 66 hours. Thus, it is imperative that ⁹⁹Mo be rapidly separated and processed since half of the supply thereof is lost every 66 hours. Additionally, once ⁹⁹mTc is generated from the ⁹⁹Mo, half the supply thereof is lost every six hours. Thus, significant infrastructure, logistical resources and coordination, and expense are required to deliver ⁹⁹mTc in time to be useful for imaging applications. Many other radioisotopes have even shorter half-lives, and may decay so rapidly as to be impractical for medical purposes.

Per the above, conventional medical isotope production technologies are inadequate to meet future demand. Furthermore, many isotopes cannot be conventionally produced from nuclear reactors or cyclotrons. Accordingly, an improved type of medical isotope production, and systems for producing these isotopes, may be beneficial.

Per the above, nuclear waste from fission reactions presents significant health and security concerns. Fission power produced using heavy metals such as uranium, for example, inherently produces highly radioactive and dangerous nuclear waste. Some products of nuclear fission in the nuclear waste material, such as spent fuel rods, are far more radioactive than uranium and other heavy elements. This highly radioactive nuclear waste may be dangerous to store, have a relatively long half-life, and cannot readily be disposed of or converted to non-radioactive material via conventional approaches. The most common waste products from “once-through” fission are strontium-90 (⁹⁰Sr), cesium-137 (¹³⁷Cs), technetium-99 (⁹⁹Tc), iodine-129 (¹²⁹I), neptunium-237 (²³⁷Np—transuranic), and americium-241 (²⁴¹Am—transuranic).

The most cost-effective conventional method of producing fission power is the “once-through” method, where nuclear energy is produced using fuel in a light water reactor and the waste is placed in long-term storage. While this method is more cost-effective in the short-term, there are additional costs associated with long-term safety and management. Over a sixty-year period, the once-through method is roughly equal in cost to a conventional combination of recycling and long-term storage (i.e., reprocessing). Due to the highly radioactive nature of nuclear waste, associated storage problems, and political issues with fission power and waste storage, reprocessing has emerged as a more desirable method of hybrid waste management.

Some forms of reprocessing include plutonium uranium extraction (PUREX), co-extraction (COEX), pyroprocessing, and transmutation. PUREX is a hydrometallurgical process where fuel elements are dissolved in concentrated nitric acid. COEX is based on co-extraction and co-precipitation of uranium, plutonium, and usually neptunium together, as well as a pure uranium stream, eliminating any separation of plutonium on its own. Pyroprocessing is currently experimental. It involves several stages, including volatilization, liquid-liquid extraction using immiscible metal-metal phases or metal-salt phases, electrolyte separation in molten salt, and fractional crystallization.

The emerging field of transmutation promises to potentially provide an ideal solution to nuclear waste since nearly-complete remediation of waste into usable fuel and/or stable on-radioactive elements is theoretically possible. However, no currently known approach is capable of achieving such results. Rather, small amounts of nuclides have been transmuted through certain techniques, including neutron irradiation in a nuclear reactor (i.e., a massive neutron flux is induced to fission heavy elements or covert light elements through adsorption), nuclear spallation processing for actinides by neutron irradiation in an accelerator, and disposal processing of cesium, strontium, and other materials by gamma ray irradiation in an accelerator.

However, conventional large-scale remediation processes are complex, have a high cost, and have low efficiencies given the amount of energy that is required. Furthermore, high strength and high energy accelerators are not readily available. Accordingly, an improved approach to nuclear waste remediation may be beneficial.

### SUMMARY

Certain embodiments of the present invention may provide solutions to the problems and needs in the art that have not yet been fully identified, appreciated, or solved by conventional nuclear processes. For example, some embodiments of the present invention may fuse light elements to a target material or each other by exposing the target material to energetic electrons in an environment containing a suitable high density nuclear fuel, such as deuterium or tritium, as a high pressure gas or in liquid or solid forms, optionally as a compound with other elements. In certain embodiments, in addition to or in lieu of the fuel, the target itself, whether solid or liquid, may contain deuterium or tritium (e.g., a “deuterated” or “tritated” target). This exposure to energetic electrons causes deeply screened tunneling and/or converts at least a portion of the metal-dissolved fuel into neutral nuclei. In the case defined as “deeply screened tunneling,” an energetic electron or electrons that possess specific individual or collective quantum properties may pass sufficiently close to a nucleus of a deuterium or tritium atom such that the electrostatic repulsion between the screened nucleus and any adjacent nucleus is not felt by the adjacent nuclei outside the much reduced screening radius for a brief period of time. This significantly increases the quantum tunneling reaction probability between the nuclei even at lower kinetic energies.

In the case defined as “neutral nuclei,” an energetic electron, or at least one electron from a collective of electrons that possess specific quantum properties, with energy less than 3 MeV, may pass sufficiently close to a nucleus of a deuterium or tritium atom and be captured by the nucleus thereof (i.e., “forced electron capture”). Some embodiments provide a suitable environment and process for creating a neutral version of deuteron and/or triton nuclei, where neutrons with certain energy levels (e.g., around 3 MeV, but optionally less or much less than 3 MeV) are brought into interaction with other neutrons, forming neutral versions of deuterons and/or tritons. While the temporal existence of such a neutral nucleus may be fleeting, it may not experience any electrostatic repulsion by adjacent nuclei and potentially may fuse with an adjacent nucleus, especially when other favorable conditions general to all fusion reactions are met, such as high fuel density and at sufficiently high kinetic energy.

Under proper conditions, at least some of the neutral nuclei and/or deeply screened nuclei fuse with nuclei in the target material, directly releasing energy. This released energy may be used for power generation, such as for driving an electric generator or a steam turbine, powering a car, powering a house, or for any other desired purpose. Heat generated as a byproduct of the nuclear reactions can also be used to heat buildings or for any other desired purpose. The various materials that are generated through neutral nuclei and/or deeply screened tunneling may be used for various applications, including application of radioisotopes for medical purposes, creation of new materials, nuclear waste remediation (i.e., transmuting a highly radioactive material into something less radioactive or benign), etc.

Some embodiments of the present invention involve combination of these enhanced fusion processes (i.e., deeply screened tunneling and forced electron capture) with additional materials and process conditions so as to cause internal multiplication of fusion events. Addition of high-Z materials to the fuel during a process in which energetic electrons are created by scattering events of high energy photon irradiation may more efficiently create energetic electrons. Other conventional nuclear processes may be combined with the methods of the present invention discussed herein, including fissioning of materials, transmuting of materials, and combining photodistintegration of deuterium-driven processes. Fissile materials may be introduced that may be deuterated and could participate in conventional neutronic-driven reactions, utilizing neutrons from enhanced fusion processes according to some embodiments of the present invention.

Some embodiments of the present invention cause the release of significant amounts of energy, which may be used for power generation, such as for driving an electric generator or a steam turbine, powering a car, powering a house, or for any other desired purpose. Some embodiments of the present invention transmute nuclear waste materials into desired elements. These elements may be non-radioactive and commercially valuable. In the process, energy may be generated and used to do useful work, such as for electricity generation. Through breaking down the highly radioactive elements of nuclear waste into more stable and non-radioactive elements, nuclear waste can be transformed into useful and lucrative materials, converting a liability into an asset.

In an embodiment, a method includes providing a sufficient density of one or more hydrogen isotopes in the form of deuterium and/or tritium gas, a deuterated or tritated liquid, a deuterated or tritated solid, a plasma, or any combination thereof as a fuel source in a reaction volume. The method also includes irradiating the fuel source with a photon beam, a direct electron beam, or both, to produce energetic electrons. The fuel source is in a liquid or solid state at room temperature, the fuel source is loaded cryogenically as a liquid, one or more high-Z materials capable of donating electrons and/or neutrons are provided in the reaction volume, materials capable of being fissioned or being fertile are provided in the reaction volume, materials capable of producing multiplication events are provided in the reaction volume, electric fields are provided in the reaction volume, magnetic fields are provided in the reaction volume, one or more materials to be transmuted are provided in the reaction volume, one or more materials to moderate and/or reflect back neutrons leaving the reaction volume are provided, or any combination thereof. The energetic electrons created by the irradiating of the fuel source and/or the one or more high-Z materials cause at least some nuclei of atoms of the fuel source to become deeply screened for a period of time and/or to become neutral nuclei, facilitating nuclear fusion.

In another embodiment, a method includes providing a sufficient density of one or more hydrogen isotopes in the form of deuterium and/or tritium gas, a deuterated or tritated liquid, a deuterated or tritated solid, a plasma, or any combination thereof, as a fuel source in a reaction volume. The method also includes exposing the one or more hydrogen isotopes, a target, or both, in the reaction volume to photon radiation, a direct electron beam, or both, causing production of delocalized energetic electrons in close proximity to nuclei of the one or more hydrogen isotopes, causing at least some nuclei of the one or more hydrogen isotopes to become deeply screened for a period of time and/or to become neutral nuclei, facilitating nuclear fusion.

In yet another embodiment, a method includes providing high density neutrons with a total energy of 3 MeV or less. Interaction between the neutrons with the total energy of 3 MeV or less forms neutral versions of deuterium and/or tritium nuclei.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a Feynman diagram illustrating quantum fluctuations between neutron-neutron (n, n) and proton-delta-minus (p, δ⁻), according to an embodiment of the present invention.

FIG. 2 is a graph illustrating reaction cross-section versus incident energy for Be-9 that demonstrates a resonant peak around 3 MeV, according to an embodiment of the present invention.

FIG. 3 is a graph illustrating reaction cross-section versus incident energy for Be-9 that shows that lower neutron energies may result in a significant reaction probability, according to an embodiment of the present invention

FIG. 4A is a perspective view illustrating a concentric plasma reactor, according to the present invention.

FIG. 4B a front view illustrating the concentric plasma reactor, according to an embodiment of the present invention.

FIG. 5 is a side view illustrating a concentric plasma reactor with a hybrid cathode, according to an embodiment of the present invention.

FIG. 6 is a side view illustrating a concentric plasma reactor with an external jacket, according to an embodiment of the present invention.

FIG. 7 is a side cutaway view illustrating a reaction chamber activated by photons, according to an embodiment of the present invention.

FIG. 8 is a perspective cutaway view illustrating a glow discharge plasma reactor, according to an embodiment of the present invention.

FIG. 9 is a side view illustrating a cathode for a glow discharge plasma reactor, according to an embodiment of the present invention.

FIG. 10 is a side cutaway view illustrating a cathode for a glow discharge plasma reactor, according to an embodiment of the present invention.

FIG. 11 is a side cutaway view illustrating a cathode embedded within a jacket, according to an embodiment of the present invention.

FIG. 12 is a side cutaway view illustrating a high pressure gamma plasma reactor with an integrated heat exchanger, according to an embodiment of the present invention.

FIG. 13 is a side cutaway view illustrating an x-ray device with a target to be transmuted substituted for a braking target, according to an embodiment of the present invention.

FIG. 14 is a side cutaway view illustrating an x-ray device with a target to be transmuted placed proximate to a braking target, according to an embodiment of the present invention.

FIG. 15 is a side cutaway view illustrating a continuous fusion reactor, according to an embodiment of the present invention.

FIG. 16 is a side cutaway view illustrating a fusion-fission reactor, according to an embodiment of the present invention.

FIG. 17 is a front cutaway view of a fuel element, according to an embodiment of the present invention.

FIG. 18 is a graph illustrating beta activities of DPE (SL1 and SL3) and DPE with TiD₂ (balance of samples) after X-ray exposure measured by alpha/beta counting system compared to the MDA (90% confidence), according to an embodiment of the present invention.

FIG. 19 is a graph illustrating beta counts of SL16 for over 12 months after initial exposure to the X-ray beam, according to an embodiment of the present invention.

FIG. 20 is a graph illustrating beta scintillation data (1 to 18 KeV spectral band, ±5% uncertainty) versus run number for DPE, TiD₂ (from SL17A), and blank vials, according to an embodiment of the present invention.

FIG. 21A is a graph illustrating samples PGL 2150 to 2153: ErD_{2.8}+D-para+Mo gamma spectra after six hours of exposure with a 15 minute counting interval (lower line illustrates cave background while upper line illustrates sample results), according to an embodiments of the present invention.

FIG. 21B is a graph illustrating samples PGL 2142 to 2145: HfD₂+D-para+Mo gamma spectra after six hours of exposure with a 15 minute counting interval (lower line illustrates cave background while upper line illustrates sample results), according to an embodiments of the present invention.

FIG. 22 is a flowchart illustrating a process for providing enhanced nuclear reactions, according to an embodiment of the present invention.

FIG. 23 is a block diagram illustrating a computing system configured to control a nuclear reactor, an x-ray device, or any other device or machine disclosed herein, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to a novel approach to, and device for, generating enhanced nuclear reactions. Novel nuclear processes enable subsequent reactions and/or combine with conventional nuclear processes including, but not limited to, fusion of light nuclei of the hydrogen isotopes deuterium and tritium. The novel processes may provide a local environment suitable for enhanced fusion reactions by reducing or eliminating the electrostatic barrier between adjacent nuclei by energetic electrons (i.e., deeply screened tunneling). Such energetic electrons may be generated locally by a high energy electron beam or by a gamma beam via scattering interactions with nuclei of the fuel (e.g., deuterium or tritium) or adjacent high-Z materials (i.e., materials with a high number of protons). As used herein, the “fuel” is the lower atomic number element that is converted into deeply screened and/or neutral nuclei or otherwise fuses with other nuclei, or with a higher atomic number element. The target, target to be transmuted, or substrate refers to the higher atomic number material that fuses with the fuel atoms via deeply screened tunneling and/or neutral nuclei. This material may participate in subsequent conventional nuclear reactions. However, the primary reaction is the fuel-fuel fusion interaction (i.e., two deuterium nuclei may fuse to form helium).

In order to understand embodiments of the present invention, a general, simplified discussion and understanding of nuclear engineering may be beneficial. All nuclear reactions may be conveniently, and very basically, described by a rate equation:

RR=N₁×N₂×σ×V

where RR is the reaction rate per unit volume per unit of time, N₁ is the number density of particles per unit volume in a first reactant, N₂ is the number density of particles per unit volume of a second reactant, a is the reaction probability cross-section measured in barns with units of length squared, and V is the reactant velocity (i.e., length over time).

Conventional hot fusion increases the RR by increasing a and V at very high temperatures, since the reaction tunneling probability scales exponentially with temperature, and the exponent starts to become appreciable at temperatures above around 10 KeV (greater than 100,000,000 Kelvin) for conventional deuterium-deuterium (D-D) or deuterium-tritium (D-T) fusion. Most current hot fusion approaches (e.g., tokomaks) actually have a very low reactant density, and focus on increasing a instead. Thermonuclear devices actually use the dramatic and instantaneous increase in N₁ and N₂ using X-ray radiation coming from explosion of a fission bomb, together with an increase in σ and V and other ingredients. Because the latter must operate efficiently to consume the fuel over very short time, designers are challenged with trying to simultaneously combine all of the elements together.

However, some embodiments of the present invention take advantage of the recognition that: (1) conventional hot plasma fusion processes operate at very low density; and (2) quantum tunneling could operate efficiently at low temperatures, and even room temperature if the fusing nuclei could be brought very near to each other without experiencing the repulsive electrostatic barrier by creating localized environments that screen the electrostatic field, or even remove it altogether.

Increasing reactant density may be accomplished in some embodiments using a high pressure fuel gas, liquid fuel, or solid fuel, or using high pressure fuel gas that is created not via compression of a gas, but rather, by starting with a cryogenically loaded reactor consisting of liquid deuterium, for example, or using solid compounds containing deuterium or tritium, e.g., deuterated plastics, or deuterated materials in which the fuel is embedded into a solid matrix as a solution, e.g., in deuterated metals. All of these will each increase N₁ and N₂ simultaneously by at least 3-4 orders of magnitude, thus increasing RR by at least 6-8 orders of magnitude (i.e., 100,000 to 10,000,000+ times). This is a very significant increase in the reaction rate indeed.

Removing the electrostatic field may be accomplished by a process broadly analogous to muon-catalyzed reactions (i.e., μCF) where a particle (a muon) with a charge of an electron is used to screen the electrostatic barrier between adjacent deuterium nuclei. In some embodiments, energetic electrons are introduced or created near the nuclei of deuterium or tritium with specific energies and quantum parameters to enable them to effectively screen these nuclei. Simply stated, adjacent nuclei could then come much closer to one another than before since they won't be experiencing the repulsive electrostatic force until they get very close to each other (i.e., “deep screening”). At that point, the finite quantum tunneling probability would result in fusion. Alternatively, energetic electrons with specific energies less than 3 MeV and quantum properties may also be captured by the nuclei of hydrogen isotopes (“forced electron capture”) in a weak force interaction more commonly observed in higher-Z materials, resulting in a nucleus that would appear, at least temporally, to be electrically neutral, and thus able to participate in fusion events with any nearby nucleus. Some embodiments provide a suitable environment and process for creating a neutral version of deuteron and/or triton nuclei, where neutrons with certain energy levels (e.g., around 3 MeV, but optionally less or much less than 3 MeV) are brought into interaction with other neutrons, forming neutral versions of deuterons and/or tritons. Deeply screened fusing nuclei would then result in conventional nuclear processes ensuing from fusion byproducts, such as energetic protons, neutrons, and other reaction products. Creation of temporal neutral nuclei may result in direct fusion with other deuterium or tritium nuclei, or fusion with any nearby material. The latter may result in subsequent fissioning or transmuting of the nearby material, depending on its properties.

In accordance with some embodiments of the present invention, energetic electrons may be created using a variety of photon scattering processes. The high energy photons may be provided by various known techniques, including a LINAC, etc. Furthermore, since scattering processes increase in efficiency with the atomic number “Z,” high-Z materials are used to create energetic electrons in some embodiments of the present invention. Combining high-Z materials that are capable of being deuterated (e.g., deuterated metals) may also be performed, combining creation of energetic electrons throughout the volume in close proximity to a high density fuel that is already embedded within the metal lattice at high stoichiometry, for example. Such high-Z deuterated materials could be incorporated throughout the reaction volume as very high surface area nano or micro particles that are also embedded in high density pure deuterium/tritium fuel in the gas, liquid, or solid states. Materials that are desired to be transformed or transmuted could also be present within the reaction volume to interact with the fuel, high-Z materials, or reaction products of enhanced reactions provided by techniques of some embodiments of the present invention.

Deep screening and forced electron capture are novel processes of some embodiments. While parallel nuclear reaction processes that originate with the photodisintegration of the deuteron have a strict lower energy limit of 2.2 MeV of the incoming photon irradiation (or alternatively, disintegration of the deuteron by an energetic electron with energy greater than 3 MeV, resulting in formation of two neutrons), there is no such fundamental limit for initiation of deep screening or electron capture mechanisms. Such reactions are complex functions of many physical and quantum parameters, including, but not limited to, properties of the nuclei, properties of the energetic electrons, how the energetic electrons were created from the energetic photons, and certain quantum parameters. Such functions are furthermore best derived from experiments in a manner analogous to determination of virtually all nuclear reaction cross-section tables. The present lack of experimental reaction cross-sections for some of the processes underlying some embodiments of the present invention does not mean that these processes could not be reduced to practice and optimized for specific purposes, since the basic process ingredients of high density, high flux of energetic photons to result in prolific production of localized energetic electrons, and related external fields could further be exploited in some of the embodiments of the present invention.

The energetic electrons in some embodiments may be produced by any suitable method for producing electrons with energy capable of causing deeply screened tunneling and/or creating neutral nuclei. For example, these energetic electrons may be generated via an externally generated energetic electron flux (e.g., plasmas, arc discharge, electrostatics), X-ray irradiation (e.g., from X-ray tubes or plasma devices), or gamma ray irradiation (e.g., from a linear particle accelerator (LINAC)) to create energetic Compton electrons and photo-electrons in the reaction system. In some embodiments, multiple energetic electron, X-ray, and/or gamma ray sources may be used. These sources may be aligned along different planes/axes in order to subject the target to radiation from multiple directions. Not only does this increase the flux of energetic electrons or radiation, but it also increases the probability of reactions occurring (i.e., RR as discussed above). Energetic electrons may also be generated by naturally occurring beta electron decay, which is radioactive decay with gamma emissions, resulting in energetic electrons through the photo-electric effect or Compton scattering, electron-positron pair production, combinations thereof, etc. This photon-to-electron process provides the ability to create the flux of energetic electrons through the entire assembly of fuel, and is not limited to an electron flux solely at the surface, as with certain electron beam initiation processes.

The localized energetic electrons may create plasma with specific properties that reduce the screening radius around the fuel nuclei (i.e., deeply screened tunneling), thus enabling quantum tunneling processes to occur at a significantly lower kinetic energy of the fuel nuclei. Some embodiments also enhance the novel processes disclosed herein using additional electromagnetic fields, materials to efficiently convert high energy photons to localized high energy electrons, materials to participate in multiplication of nuclear events to sustain reactions, materials to be transmuted or transformed, etc.

In some embodiments, high-density hydrogen isotopes, such as deuterium and/or tritium, are irradiated with a high energy photon beam, such as an X-ray beam or a gamma ray beam. One or more of the following may also be provided in some embodiments to result in novel processes: (1) high-density hydrogen isotopes that are in liquid or solid state at room temperature, or loaded cryogenically as liquid; (2) high-Z materials, including powders, nanoparticles, and materials capable of donating electrons and neutrons to nuclear activation processes; (3) materials capable of being fissioned or being fertile (i.e., material that by itself is not fissile using thermal neutrons, but could become so following neutron absorption, e.g., U-234 into U-235 or Pu-238 into Pu-239); (4) materials capable of producing multiplication events (e.g., (n,2n), (n,3n), etc.); (5) electric fields; (6) magnetic fields; and/or (7) plasma of hydrogen isotopes such that the ion temperature is cold and the electron temperature is hot. Optionally, deuterated materials as a fuel source, materials to be transmuted, and/or materials to moderate and/or reflect back neutrons leaving the reaction volume may be provided.

The approach of some embodiments combines both conventional and novel nuclear processes. Conventional nuclear processes include photodisintegration of deuterium nuclei, which may lead to subsequent nuclear events in the presence of other deuterium nuclei nearby in a gaseous, very high pressure environment, or direct disintegration of the deuteron by energetic electrons with energy greater than 3 MeV. These events may include kinetic heating of adjacent deuterons via elastic scattering, providing deuterons with high kinetic energy sufficient for direct D-D fusion. Products of such fusion events could then trigger other conventional nuclear processes, as described in Didyk et al., for example. See Alexander Y. Didyk and Roland S. Wisniewski, “Nuclear reactions, induced by γ-quanta, in palladium saturated with deuterium surrounded by dense deuterium gas,” EPL Journal 99 (July 2012) 22001.

Novel nuclear processes of some embodiments make direct use of the creation of neutral deuterium and/or tritium nuclei, enhanced screening of the electrostatic barrier between deuterium and/or tritium nuclei and adjacent nuclei, or both, resulting in nuclear fusion. Products of such fusion events could trigger other conventional nuclear processes as described in Didyk et al., for example. In contrast, conventional processes must rely on the fusion process initiation via direct photodisintegration of the deuterium nucleus or electron initiated disintegration of the same, which is understood to begin only when the gamma energy is above a threshold of 2.2 MeV or an electron energy of greater than 3 MeV, respectively, as discussed above.

However, the novel processes of some embodiments, which could be combined with conventional reaction processes, are not limited by any particular threshold energy. The additional role of high energy photons that are scattered from matter, thus generating high energy electrons, is to enhance fusion reaction rates by reducing the electrostatic screening radius, thus enabling fusion with increased tunneling probability at lower kinetic energies of the participating nuclei. Another potential role of high energy (but less than 3 MeV) electrons is to be captured by the deuterium or tritium nuclei, resulting in neutral versions of the same, further resulting in at least temporal elimination of the electrostatic barrier to interact with other nuclei.

More specifically, forced electron capture by the fuel gas nuclei affects the quark constituents of the nucleons via their interactions through the electroweak and strong fields. In embodiments using hydrogen isotopes as a fuel gas, interactions of energetic electrons with energy less than 3 MeV with quarks confined by the gluon fields in baryons (i.e., protons in this case) of hydrogen isotopes with atomic masses of two or greater (i.e., deuterons or tritons) allows for the creation of neutral transient nuclei, hereinafter referred to as ₀²D nuclei or particles when created by forced electron capture by deuterons or ₀³T nuclei or particles when created by forced electron capture by tritons. The energetic electron will be captured by the nucleus via the weak field interaction, and the up quark is converted to the down quark. The neutral ₀²D nucleus has a mass approximately equal to that of a deuteron and the ₀³T nucleus has a mass approximately equal to a triton. However, these neutral nuclei no longer experience the repulsion of the Coulomb barrier. This allows the neutral nuclei to interact with any nearby nuclei of other atoms, resulting in a fusion reaction and potential subsequent fissions of the newly created nuclei.

Some embodiments provide a suitable environment and process for creating a neutral version of deuteron and/or triton nuclei, where neutrons with certain energy levels (e.g., around 3 MeV, but optionally less or much less than 3 MeV) are brought into interaction with other neutrons according to:

₀¹n+₀¹n→₀²D+γ (1)

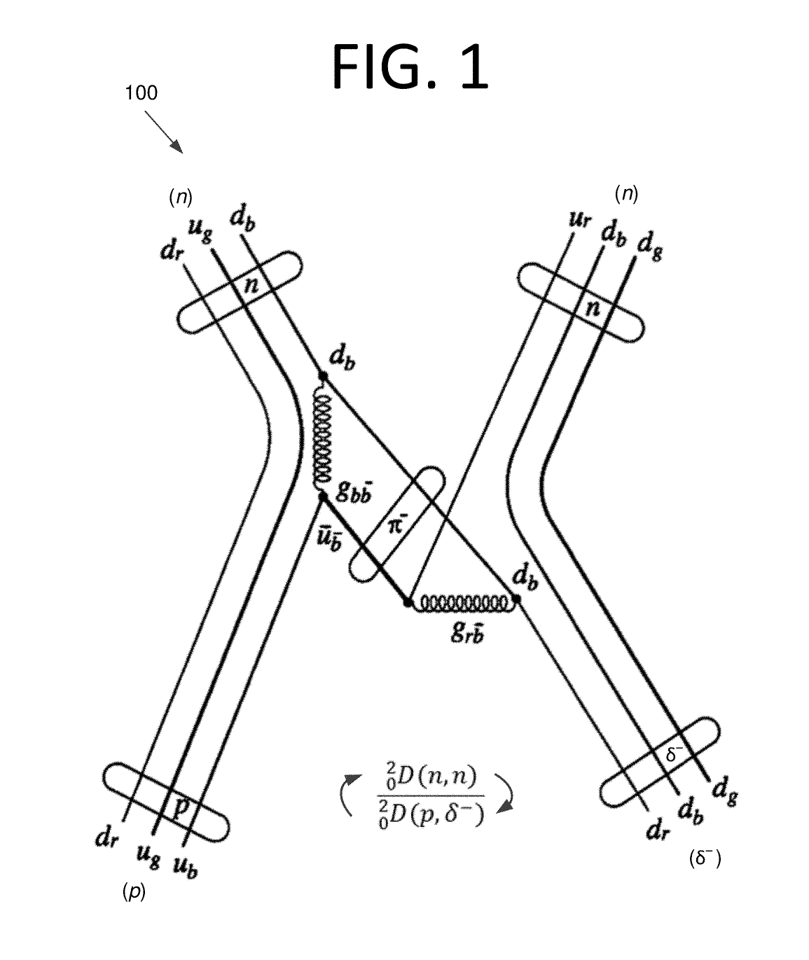

forming a neutral version of a deuteron or triton. Indeed, ₀²D could be described quantum mechanically as two neutrons or as a proton and another elementary particle called a “delta minus” (δ⁻) with a negative charge. See Feynman diagram 100 of FIG. 1.

The two states of ₀²D are continuously being exchanged in a process called quantum fluctuations, but the resulting nucleus is always electrically neutral. While other quantum properties of a neutral deuteron that originate from a forced electron capture process or from the interaction between two neutrons are different (e.g., spin), for the purpose some embodiments of the present invention, their electrical neutrality is a key shared property. Thus, the concept of a neutral deuteron (or triton) referred to herein may incorporate both processes of formation of an electrically neutral nucleus. The existence of an internal two neutron cluster may be well illustrated in the interaction between a neutron or gamma photons and ₄⁹Be. The nucleus of ₄⁹Be is a cluster including two highly stable alpha particles, with a single neutron that loosely interacts with the two alpha particles via the gluon field:

₄⁹Be:(₂⁴α|₀¹n|₂⁴α) (2)

Upon the interaction between a neutron and ₄⁹Be according to:

₀¹n+₄⁹Be→₂⁶He+₂⁴α (3)

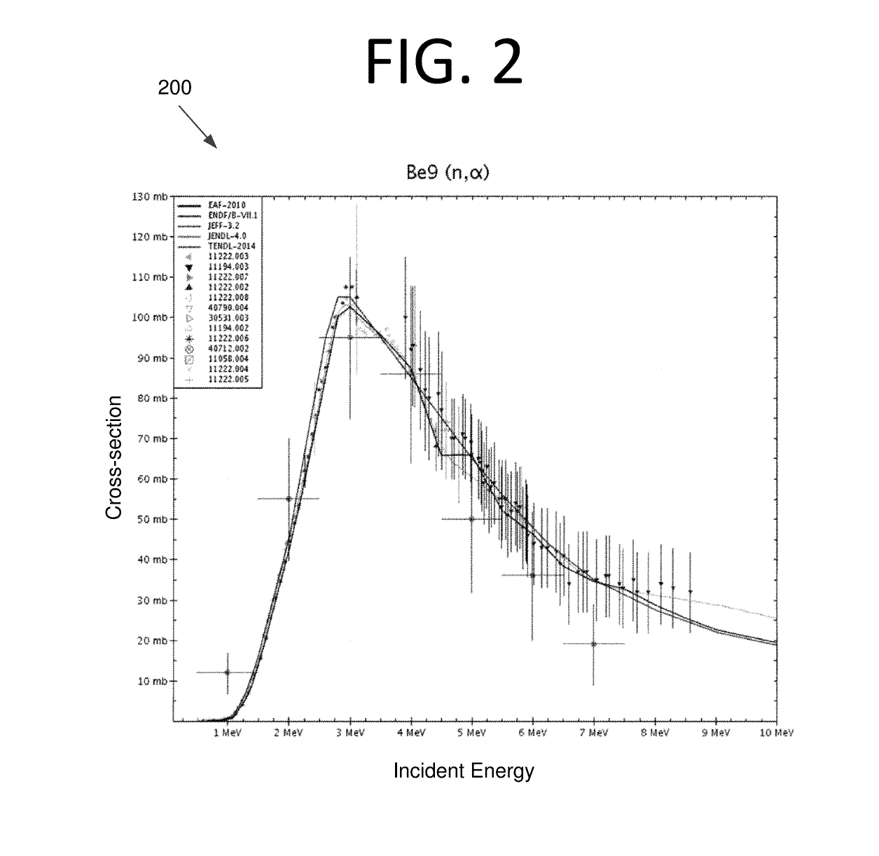

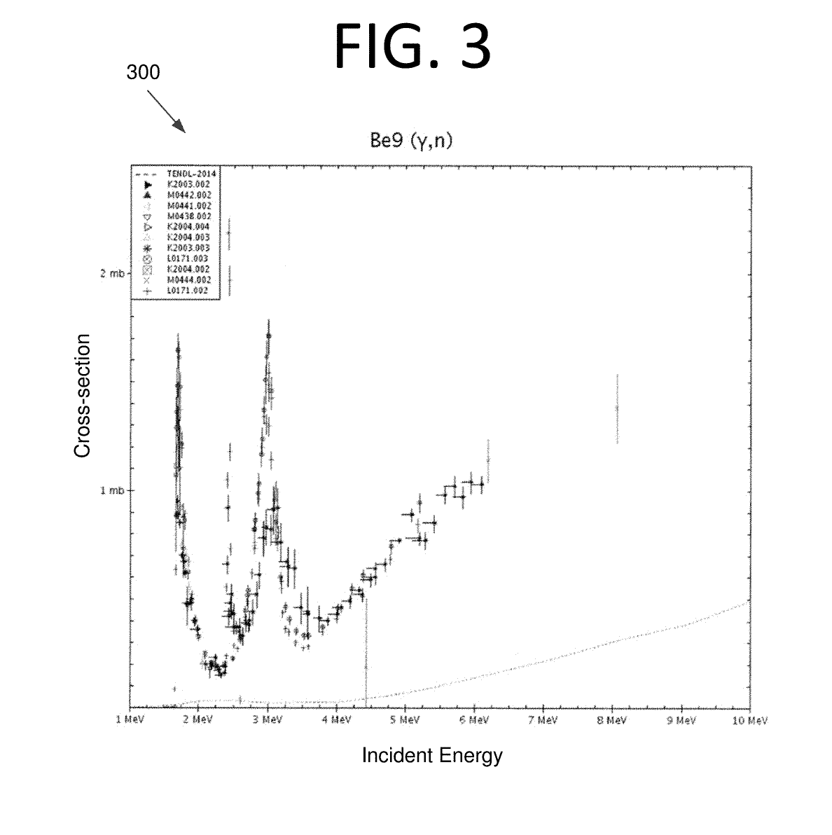

the He-6 nucleus is known to be a halo nucleus, essentially a core comprised of an alpha particle surrounded by orbiting “cloud” of two neutrons that comprise the neutral particle. The experimental evidence for this internal two-neutron cluster is readily appreciated when considering the reaction cross-section (see graph 200 of FIG. 2) that clearly demonstrates a resonant peak around 3 MeV. However, much lower neutron energies could also result in a significant reaction probability, as also shown in FIG. 3. The He-6 nucleus is, perhaps surprisingly, quite stable, surviving for 807 ms and most likely decaying to Li-6 through a beta decay. A second branch of the same reaction, which is much less likely, is provided by:

₀¹n+₄⁹Be→₄¹⁰He+γ (4)

but also exhibiting the same resonant peak at 3 MeV. The same resonant signature of the internal two-neutron structure at 3 MeV is still evident in graph 300 of FIG. 3, with the interaction of gamma photons with Be-9 according to:

γ+₄⁹Be→₄⁸Be+₀¹n (5)

₄⁸Be→₂⁴α+₂⁴α,τ<10⁻¹⁶s) (6)

In this case, the gamma photons at 3 MeV excite the two alpha particles within the Be-9 nucleus to form a temporal cluster with the single loose neutron within the Be-9 nucleus, as clearly evident from the resonant condition at exactly the same energy level as with the interaction between an energetic neutron and Be-9. All of these three reactions point to a two-neutron configuration that is preferentially formed around 3 MeV in some embodiments, although the resonant peak is quite wide, leading to a longer duration of the cluster than in typical strong force interactions.

Yet another role of high energy electrons at sufficient density is to cause localized production of plasma pockets, combining cold deuterons and/or tritons with hot electrons. The Debye length of such two-temperature plasma, essentially the screening radius around the plasma ions, is significantly reduced to enable enhanced fusion tunneling probability. These and other novel nuclear processes that are induced by enhanced electron screening effects and/or removal of the barrier in dense deuterium and/or tritium environments result from the methods and devices of some embodiments of the present invention.

The systems and methods for transforming and transmuting materials and extracting energy by nuclear reactions in some embodiments provide for transformation and transmutation of materials to produce products having desired properties, as well as releasing usable energy. A material to be transformed may include a reactant composed of at least one element having a first atomic mass associated therewith and containing at least one isotope of hydrogen having an atomic mass of at least two, such as deuterium, tritium, or a combination thereof. The material to be transformed may be in the form of a metallic crystal lattice, for example, loaded with the at least one isotope of hydrogen, such as, for example, palladium, silver, nickel, lithium, titanium, uranium, thorium, scandium, vanadium, gallium, germanium, yttrium, zirconium, niobium, molybdenum, ruthenium, rhodium, lanthanum, hafnium, tantalum, tungsten, rhenium, thallium, actinium, hydrides thereof, and alloys and combinations thereof. Alternatively, the material to be transformed may be a non-metallic and/or non-crystalline material containing hydrogen, such as deuterated hydrocarbons, deuterated silicons, nanotubes or other nanostructures loaded or doped with hydrogen, or the like. In certain embodiments, deuterated paraffin may be used, where at least some of the hydrogen atoms in the paraffin are replaced with deuterium.

It should be understood that any material which may be hydrided may be used as the initial material, such as, for example, single-walled or double-walled carbon nanotubes. Double-walled carbon nanotubes in particular have an internal spacing consistent with the lattice spacing of palladium-silver lattices, the usage of which in experiment will be described in detail below. Alternatively, materials such as silicon, graphene, boron nitride, silicene, molybdenum disulfide or ferritin may be used, although it should be understood that substantially two-dimensional structures, such as graphene, boron nitride, silicene and molybdenum disulfide are not hydrated similar to their three-dimensional counterparts and may be subjected to a separate process, specifically with the two-dimensional structure being positioned adjacent one of the above materials, as will be described in greater detail below. Similarly, ferritin and other complex materials may be filled or loaded with hydrogen using methods specific to the particular material properties. In general, the initial material may be any suitable material which is able to readily absorb and or adsorb hydrogen isotopes, such as, for example, metal hydrides (e.g., titanium, scandium, vanadium, chromium, yttrium, niobium, zirconium, palladium, hafnium, tantalum, etc.), lanthanides (e.g., lanthanum, cesium, etc.), actinides (e.g., actinium, thallium, uranium, etc.), ionic hydrides (e.g., lithium, strontium, etc.), covalent hydrides (e.g., gallium, germanium, bismuth, etc.), intermediate hydrides (e.g., beryllium, magnesium, etc.), and select metals known to be active (e.g., nickel, tungsten, rhenium, molybdenum, ruthenium, rhodium, etc.), along with hydrides thereof, as well as alloys with non-hydriding materials (e.g., silver, copper, etc.), suspensions, and combinations thereof.

In addition, in the case of formation of neutral nuclei, a neutral nucleus may fuse with a nucleus of at least one reactant of a material to be transformed to form a secondary material including at least one reactant having a second atomic mass associated therewith, where the second atomic mass is greater than the first atomic mass (in fusion events), or where the second atomic mass is smaller than the first atomic mass (in fission events). The initial material may be selected such that the element having the second atomic mass decays into a desired material, releasing usable energy in the process. In addition to the neutral nuclei fusing with nuclei of the initial material, the neutral particles may fuse with isotopes of hydrogen which did not react with the heavier nuclei, producing helium and other heavier materials, along with further energy release. As a further alternative, the neutral nuclei produced by the above electron capture process may be projected in a beam, similar to the production of a neutron beam, to be directed on a further material to be transformed, such as, for example, graphene, silicene, boron nitride, or molybdenum disulfide. As noted above, substantially two-dimensional structures, such as graphene, silicone, boron nitride, and molybdenum disulfide, are not hydrated similar to their three-dimensional counterparts and may be subjected to a separate process and also be used for different purposes, such as the construction or manufacture of specialty materials and products, as will be described in greater detail below.

In some embodiments, a hydrating and/or non-hydrating material is placed in close proximity to the nuclear fuel, or is deuterated or titrated directly by the nuclear fuel. The material may be or include one or more metal hydrides (e.g., titanium, scandium, vanadium, chromium, yttrium, niobium, zirconium, palladium, hafnium, tantalum, etc.), lanthanides (e.g., lanthanum, cesium, etc.), actinides (e.g., actinium, thallium, uranium, etc.), ionic hydrides (e.g., lithium, strontium, etc.), covalent hydrides (e.g., gallium, germanium, bismuth, etc.), intermediate hydrides (e.g., beryllium, magnesium, etc.), select metals known to be active (e.g., nickel, tungsten, rhenium, molybdenum, ruthenium, rhodium, etc.), hydrides thereof, alloys with non-hydriding materials (e.g., silver, copper, etc.), and/or combinations thereof.

In some embodiments of the present invention, a metallic cathode is brought into contact with an irradiated sample, resulting in creation of a plasma sheath around the cathode. The ions in the cold ions/hot electron plasma created via high energy photon irradiation are then accelerated in the sheath towards the cathode. Since the ions are deeply screened by the energetic electrons resulting from high energy photon scattering, even modest electrode potential on the cathode could accelerate the ions to effectively tunnel the electrostatic barrier. In some embodiments, the accelerated ions within the plasma sheath are irradiated by high energy photons. In certain embodiments, the irradiation of the accelerated ions within the sheath by high energy photons may result in creation of localized electrons that screen the ions, allowing for fusion events with other nuclei, including those of or embedded within the cathode.

In some embodiments, the cathode is made of a metal capable of hydrating deuterium or tritium, thus creating advantageous fusion environment by significantly increasing the number density of the nuclear fuel within the cathode, which is in turn being bombarded by the accelerating ions. In certain embodiments, glow discharge plasma is generated using low pressure gaseous deuterium, tritium, or a combination thereof. In some embodiments, the cathode and/or anode include metal that is capable of being hydrated.

In certain embodiments, electromagnetic fields could be constructed around or within the sample volume to further shape the internal plasma field to enhance fusion tunneling probability. Such fields may be used to contain the plasma field, to focus the plasma, and/or to develop specific shaped high gradients within the plasma (such as pinch regions) to result in development of internal waves or instabilities that could further be increased via coupling with the magnetic or electrical fields. In some embodiments, electromagnetic fields could be constructed around or within the sample volume to further interact with deuterated materials. In some embodiments, the deuterated materials are metals. The deuterated materials may be capable of supporting conduction band electrons (e.g., carbon nanotubes).

In some embodiments, the electromagnetic fields include magnetic fields, electrical fields, and/or laser light that is directed to interact with free or surface bound electrons in metals embedded or placed nearby the active nuclear fuel. The electromagnetic fields may be tailored to cause resonant coupling behavior for enhancement of the nuclear processes provided by the present invention. The resonant coupling behavior may occur within the electromagnetic field and/or within other elements of the system, including phonon interaction and/or hydrating deuterons within the lattice of the hydrated system.

In some embodiments, a high number density of the nuclear fusion fuel containing deuterium or tritium may be provided as deuterated or tritated solids. In certain embodiments, the deuterated or tritated solid is a metal, paraffin, or another suitable material. The nuclear fuel in some embodiments may include material selected from Table 3 below.

However, the nuclear fuel may be a gas, a liquid, and/or a solid in some embodiments without deviating from the scope of the invention. Such fuels may be relatively easily loaded into a reaction vessel without requiring high pressures to achieve high number density of the nuclear fuel to enable fusion processes to occur. In some embodiments, the nuclear fuel is loaded using high pressure compressors. In certain embodiments, the nuclear fuel is loaded cryogenically as a liquid into the reaction vessel.

In some embodiments, deuterated fuel or fuels are selected that have different molecular weights and composition to provide direct control over the internal pressure in the reaction vessel once in the gas/plasma state. In some embodiments, the nuclear fuel and additional reactant materials could participate in essentially aneutronic nuclear reactions. In certain embodiments, the nuclear reactions result in low energy or low generation rate of gamma irradiation.

Per the above, in some embodiments, high-Z materials are used. Such materials may produce large amounts of high energy electrons, depending on the desired photon energy, via Z-dependent cross-sections of various photon scattering processes that are dominant in different photon energy regimes. In some embodiments, the high-Z material may also be capable of being deuterated or tritated. In certain embodiments, the high-Z materials are incorporated within the nuclear fuel as a metal matrix, deuterate-capable metal, high surface area dendritic or nanoparticle microstructures, and/or other configurations or combinations thereof.

In some embodiments, a fissile or fissionable material may be incorporated into the reaction vessel to provide an enhanced overall nuclear reaction rate by creating energetic reaction products and potentially participating in multiplication or subsequent events of reaction products. The fissile material may include, but is not limited to, uranium, thorium, plutonium, or any other actinide. In certain embodiments, other materials may be added into the reaction vessel to provide enhanced overall nuclear reaction rate by fissioning subsequent to generation of reaction products from a primary photodisintegration or from a direct D-D or D-T fusion with sufficiently high photon energy, including, but not limited to, lithium and/or boron.

In some embodiments, the irradiation by photons occurs by using X-ray energies to primarily scatter electrons via the photoelectric effect from embedded high-Z material within the reaction chamber. The very high reaction cross section for this process efficiently scatters k-shell electrons, thus creating locally well-screened nuclear fuel ions well below the photodisintegration barrier of deuterium.

In certain embodiments, neutrons with energy preferably at or around 3 MeV, but optionally at lower energies, are brought into interaction with other neutrons at rest. Alternatively, two neutron beams of combined energies preferably at 3 MeV, but optionally at lower combined energies, are brought into mutual interactions.

In some embodiments, the neutrons of specific desirous energy levels are created from other nuclear processes. In a non-limiting example, neutrons with energy of 3 MeV are created by providing a photon beam of 8.2 MeV into a high density deuterium environment, causing photodistintegration of the deuterons, which releases both proton and neutrons of equal energy of 3 MeV each. Additionally or alternatively, providing a large flux of photons above but near the 2.2 MeV photodisintegration barrier may result in low energy neutrons that may interact to form neutral particles. Other techniques for forming a high density neutron environment with specific levels of desired energies are also possible through additional processes, such as gamma interaction, neutron moderation, and other suitable techniques.

In certain embodiments, a high voltage cathode is introduced into the reaction chamber to further facilitate fusion reactions in the plasma sheath region near the cathode. In some embodiments, the high energy photons are provided below the photodistintegration barrier of deuterium. In certain embodiments, the material to be transformed into a radioisotope is embedded within or brought into close proximity to the active nuclear fuel.

In some embodiments, the material to be transformed is irradiated using high energy photons. In certain embodiments, the nuclear processes result in fracture of nuclei that are stable. In some embodiments, materials to be transformed result in metastable isotopes, or in isotopes with nuclei comprised of quark clusters with either less or more than three quarks.

In some embodiments, a device for generating enhanced nuclear reaction rates includes a reaction vessel that holds nuclear fuel including deuterium and/or tritium, metals capable of being hydrated, high-Z materials, materials to be transformed or transmuted, and/or additional elements capable of participating in nuclear reactions. The device also includes a source of high energy photons or electrons and a heat transfer element that removes heat from the reaction vessel. In certain embodiments, the photon or electron energy is below 2.2 MeV.

The reaction vessel may be surrounded by neutron moderating material and/or a neutron reflecting material. A magnetic field induction device may be included to induce electromagnetic fields within the reaction vessel. The magnetic field may be provided by a permanent magnet, an electromagnet, a laser source, or any combination thereof in some embodiments. In some embodiments, the reaction vessel includes a cathode.

In certain embodiments, a device includes a reaction vessel, a plasma generator, optionally a source of high energy photons or electrons, and a heat transfer element that removes heat from reaction vessel. The plasma may be a glow discharge plasma, a hot plasma, a two-temperature plasma with cold ions and hot electrons, or any combination thereof in some embodiments. In certain embodiments, the heat transfer element participates in nuclear processes. For instance, the heat transfer element may be configured to reflect neutrons and/or to moderate neutrons.

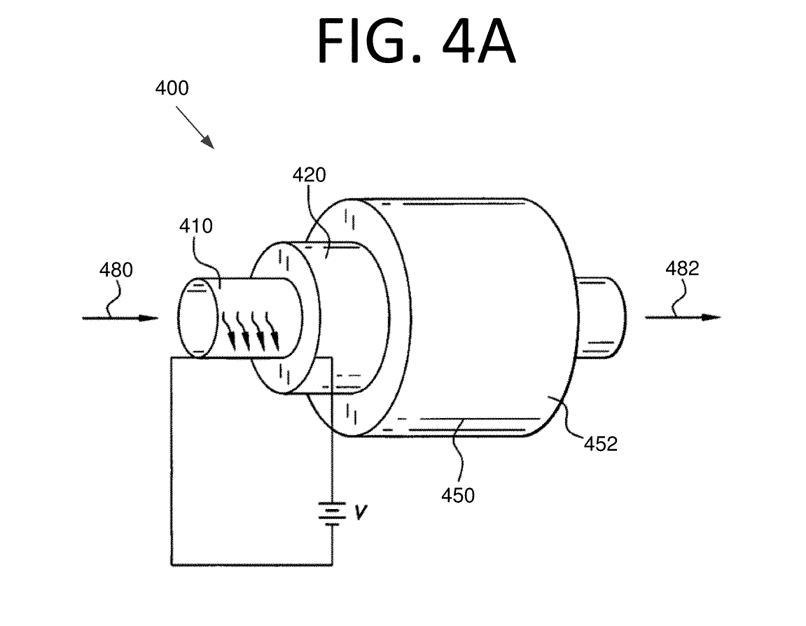

FIGS. 4A and 4B are side and front views, respectively, illustrating a concentric plasma reactor 400, according to an embodiment of the present invention. Concentric plasma reactor 400 may be utilized to carry out sufficient nuclear reactions to generate useful thermal or electric output to provide power for various applications, and/or to transmute materials. In some embodiments, the size of concentric plasma reactor 400 may be scaled for specific applications. For instance, a relatively small reactor or series of reactors (e.g., the size of a finger or smaller) may be used to provide power for a home, a car, or any other suitable purpose. On the other end of the scale, large reactors may be used for industrial applications or to provide grid-level power. The use of reactors of varying sizes for customized applications could reduce or eliminate altogether the need for grid power.

High voltage power supply V is connected across a cathode 410 and an anode 420 to generate glow discharge plasma. In this embodiment, molecular deuterium gas is broken into atomic deuterium. However, in other embodiments, other suitable fuels may be used, such as tritium, deuterated hydrocarbons, deuterated silicons, etc. One of ordinary skill in the art will also appreciate that the same process may be used for tritium, or a combination of deuterium and tritium.

The atomic deuterium atom is ionized to form a D+ ion 422 by the plasma formed between anode 420 and the cathode 410. Electrons (e⁻) are generated by cathode 410 and accelerated away in the intense local fields found in the plasma sheath. As a result, omnidirectional X-rays 430 are formed. The X-rays that penetrate into cathode 410 produce energetic photoelectrons and Compton electrons that interact with deuterons loaded in the surface of cathode 410, which is a metal in this embodiment. This causes the creation of ₀²D neutral nuclei in cathode 410 via deeply screened tunneling (neutral in effect) and/or forced electron capture (actually neutral).

As shown, cathode 410 is cylindrical and is surrounded by a concentric anode 420, forming a cylindrical shell. High voltage power supply V creates the driving potential difference between anode 420 and cathode 410. The concentric, cylindrical arrangement allows intense acceleration of D+ ions 422 toward anode 420, increasing number density due to geometrical considerations of going from a larger surface area to a smaller surface area, and also due to the high accelerating voltages provided by power supply with a suitable voltage V. D+ ions 422 that are accelerated through the plasma sheath reach a high KeV energy value when impacting on cathode 410, causing mobility of hydrogen isotopes contained in cathode 410, which results in D-D stripping fusion reactions.

Anode 420 and cathode 410 may be made of any suitable material providing properties facilitating sufficient reaction rates and thermal effects. Cathode 410 may be formed from a material that is able to readily absorb and/or adsorb hydrogen isotopes, including, but not limited to, metal hydrides, lanthanides, actinides, ionic hydrides, covalent hydrides, intermediate hydrides, and select metals known to be active (e.g., nickel, tungsten, rhenium, molybdenum, ruthenium, rhodium, etc.), hydrides thereof, as well as alloys with non-hydriding materials (e.g., silver, copper, etc.), suspensions, and combinations thereof. Additionally, materials such as thoriated tungsten may provide an initial ionizing source to create the initial ionization path to ignite the glow discharge plasma and may contribute to the initial deeply screened and/or neutral nuclei in cathode 410.

Reactant gas 440 (deuterium in this embodiment) is introduced at pressures required for the reaction, typically on the order of Torr. However, lower or higher pressures may be used, depending on the reaction rate and power supply. It should be understood that reactant gas 440 could be any other suitable gas in some embodiments. High voltage power supply V may be powered to initiate the reactions. One of ordinary skill in the art will readily appreciate that voltages on the order of 65 kV or more may be used, dependent upon the particular implementation. A higher voltage will generate higher energy D+ ions in the plasma sheath and higher energy photons (X-ray) that can generate energetic Compton electrons and photoelectrons in cathode 410, which would increase reaction rates and output power.

A pressure vessel 450, formed concentrically about cathode 410 and anode 420, is insulated by a dielectric insulating layer 460 to contain the plasma-induced reactions. A neutron reflector 452 may be made of materials such as beryllium and may be positioned about pressure vessel 450 for reflecting neutrons back into reactor 400 to harness their energy for greater energy output. Heaters 470 are used to raise the temperature of the interior chamber to a suitable temperature to facilitate the reactions (i.e., increasing V), thus providing the desired mobility to the fuel. Once reactor 400 reaches a self-sustaining mode, heaters 470 may be turned off. As shown in FIG. 4B, cathode 410 may be hollow, allowing the interior thereof to serve as the center core fuel source that allows the flow of a high pressure fuel gas (here, deuterium) or other high number density materials. Because cathode 410 is hollow in this embodiment, an input flow 480 and an output flow 482 of fuel gas flows through reactor 400. Hollow cathode 410 serves as a reaction site for the D-D reactions and as a convenient system for extracting the heat generated by reactions and maintaining acceptable reactor operating temperatures. In FIG. 4A, the relatively low temperature, high number density input flow 480 of fuel flows into reactor 400 to cool reactor 400 and cathode 410. This fuel flows out of the reactor via output flow 482 at much higher temperatures, thus carrying away the generated thermal energy. This thermal energy can be used to do work, such as heating a fluid to drive a steam turbine, heating a building, etc. A heat exchanger (not shown) may be used to cool the fuel and convey this thermal energy.

The fuel source may be mixed with certain materials, such as hydrided metals or materials chosen for their superior (n, 2n) performance to multiply neutrons. (n, 2n) means that for any neutron of a certain energy hitting this material, two neutrons will be liberated. Also, materials such as Ag, Rh, V, etc. (hereinafter referred to as “metal converters”) may be included. These materials have high radiative capture cross sections for thermal neutrons (n, γ), thus causing energetic gamma rays and/or energetic electron emissions to deep screen or to create additional neutral nuclei to internally enhance, propagate, or accelerate the reaction. In FIGS. 4A and 4B, cathode 410 is positioned internal to anode 420. However, in certain embodiments, these relative positions may be reversed. It should further be noted that although concentric reactor 400 is shown having a cylindrical configuration, in other embodiments, a reactor may alternatively be configured to have a spherical or other three-dimensional geometrical configuration, with the anode surrounding the cathode or vice versa.

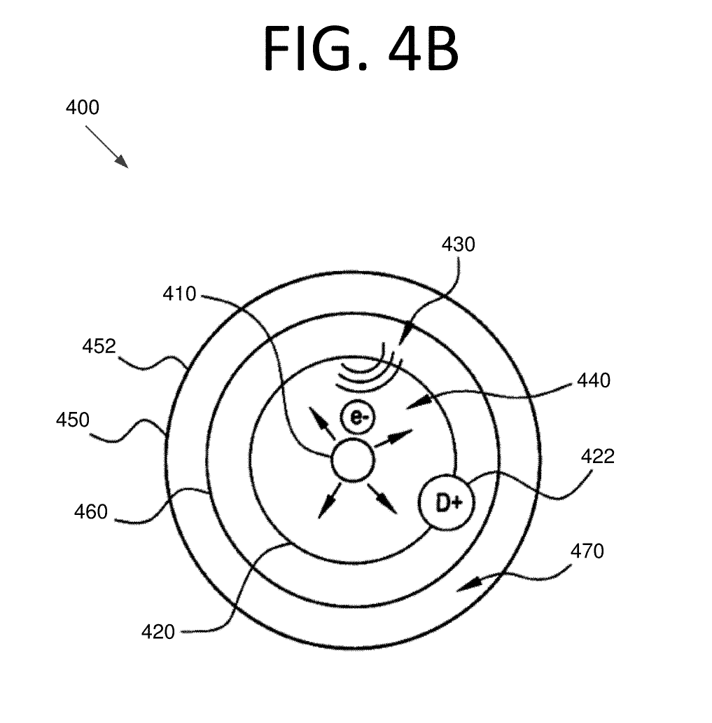

FIG. 5 is a side view illustrating a concentric plasma reactor 500 with a hybrid cathode 510, according to an embodiment of the present invention. The architecture of reactor 500 is similar to that of reactor 400 of FIGS. 4A and 4B. Reactor 500 has a voltage source V, a pressure vessel 550, a neutron reflector 552, and an anode 520, as well as an input flow 580 and an output flow 582 of fuel gas. However, reactor 500 includes a hybrid cathode 510 with a textured surface 512.

Hybrid cathode 510 has a surface morphology (i.e., textured surface 512) for creating local high-electric field lines that accelerate electrons to higher energies. This causes higher energy electrons to be generated via the photoelectric effect or Compton scattering in cathode 510. These higher energy electrons then proceed to create deeply screened and/or neutral nuclei in the hydrided material of cathode 510. These electrons may subsequently generate X-rays of higher energies in the plasma sheath. Energetic X-rays penetrate deeper into hybrid cathode 510, thus creating more neutral nuclei than with a non-hybrid cathode, such as cathode 410 of FIG. 4A. Textured surface 512 can be formed by any suitable technique, including, but not limited to, physical vapor deposition, chemical vapor deposition, sputtering, etc. Alternatively, micromachining or 3D printing may be used to create micro-sized features with the necessary aspect ratio to increase the local electric field effect.

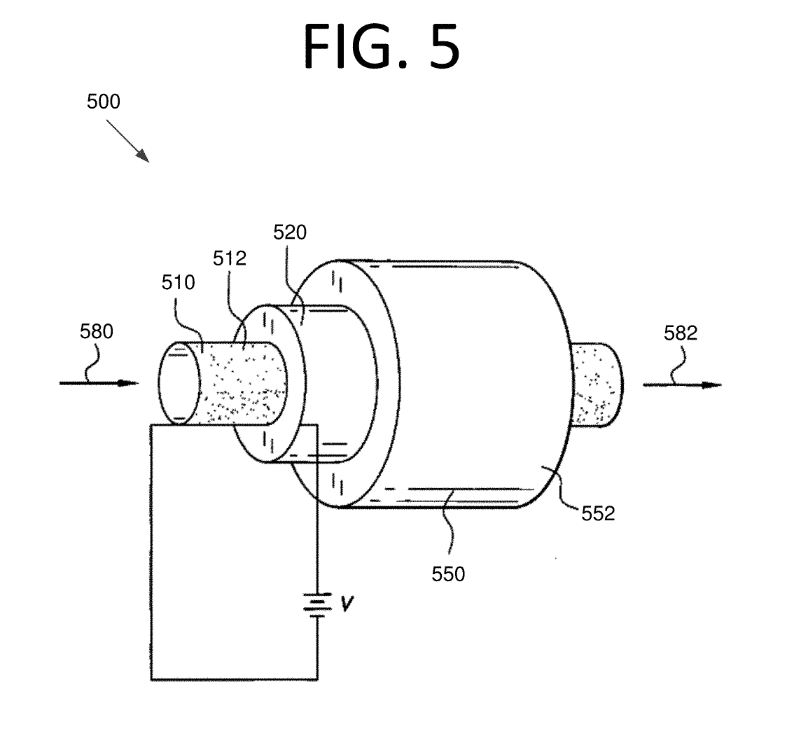

FIG. 6 is a side view illustrating a concentric plasma reactor 600 with an external jacket 690, according to an embodiment of the present invention. Jacket 690 is positioned externally to cathode 610 and anode 620. As with reactor 500 of FIG. 5, reactor 600 has a voltage source V, a pressure vessel 650, a neutron reflector 652, an anode 620, and a hybrid cathode 610 with a textured surface 612, as well as an input flow 680 and an output flow 682 of fuel gas.

a Jacket 690 is filled with a high number density hydrogen isotope material in this embodiment. This material is selected to: (1) provide additional fuel to react with any neutrons leaving the reaction zone between anode 620 and hybrid cathode 610; (2) mix with (n, 2n) material to multiply the neutrons available for reactions; and (3) mix metal converters (e.g., Ag, Rh, V, etc.). Further, the fill material in jacket 690 utilizes thermal neutrons, resulting in gamma energy that enhances the creation of electrons through the photo-electric effect and Compton scattering and metal converter materials that convert thermal neutrons to energetic electrons. Both of these effects provide energetic electrons that will create deeply screened and/or neutral nuclei in the high number density material in jacket 690, thus generating additional thermal output. As such, jacket 690 is, in essence, a “fuel jacket” in this embodiment.

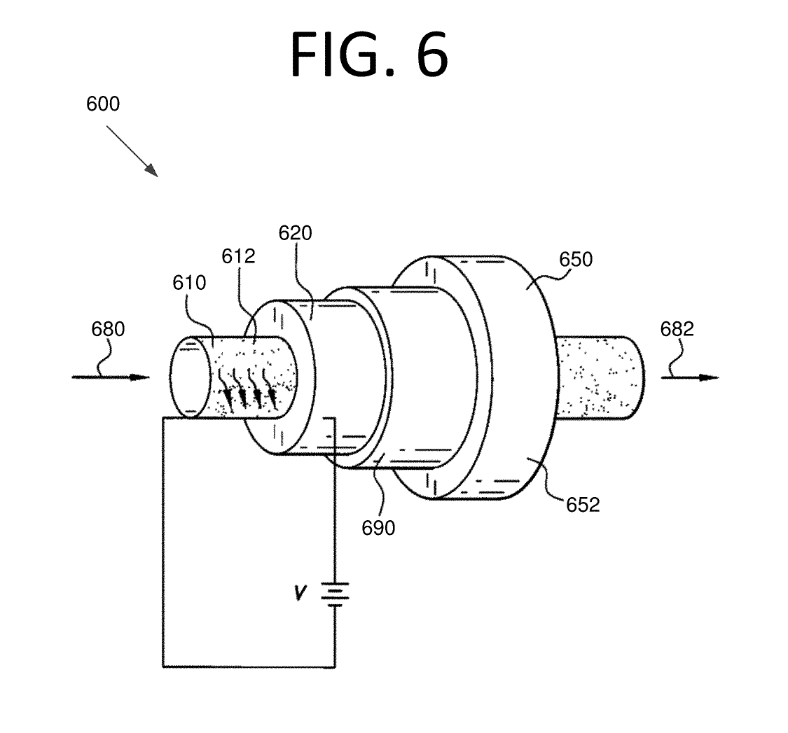

Further testing was performed using a reaction chamber 700, activated by photons in the form of an X-ray beam 720, as illustrated in FIG. 7. Reaction chamber 700 includes a reactor tube 710 containing reactants 740. Reaction tube 710 was exposed to X-ray beam 720, releasing sufficient energy photons to the reactants and, through the photoelectric effect and Compton scattering, supplying electrons of sufficient flux and energy (e.g., over 5 to 6 keV) to reactants 740. A thermocouple 730 was installed in the sealed test unit through a seal gland for measuring reactant temperatures as a function of beam time. Reactants 740 were positioned in reaction tube 710 at a location closest to the X-ray source. Additional thermocouples were used to measure the exterior of reaction tube 725 and the X-ray head temperature for purposes of comparison. In a first experiment, reactants 740 in reactor tube 710 included small amounts of deuterated polyethylene (0.08 grams) having high number density deuterium bonded to carbon atoms. In a second experiment, reactants 740 in reactor tube 710 included small amounts of alternating layers of deuterated polyethylene and deuterated polyethylene plus preloaded titanium-deuteride shavings, with a total mass of 0.16 grams.

X-rays with 200 KeV end energy, with currents up to 1 milliamp, were directed at reactor tube 710. Temperature measurements showed that the internal temperature of reactants 740 increased by over 5° C. in the first experiment using deuterated polyethylene, and by over 14° C. in the second experiment using the alternating layers of deuterated polyethylene and deuterated polyethylene plus preloaded titanium-deuteride shavings. Subsequent counting of the particles from the reactor tube in the second experiment showed energetic electron activity above background levels immediately after the test. These counts increased by approximately 50% when measured again after 20 minutes. Subsequent tests with larger masses of reactants showed larger temperature rise and neutron counts that were clearly above background levels when the X-ray beam was directed at reaction chamber 700.

CR-39 nuclear track detectors were placed adjacent to the reactor tube and were used to determine whether there was any evidence of neutron and/or charged particle activity. Subsequent readings of the CR-39 nuclear track detectors indicated the presence of neutrons and charged particle activity above background levels. When the same test reactor chamber configuration was loaded with normal hydrogen-based (atomic mass of 1) polyethylene and exposed to the same photon energy levels, there was no temperature rise above background, and no detectable neutron or energetic electron emissions above background.

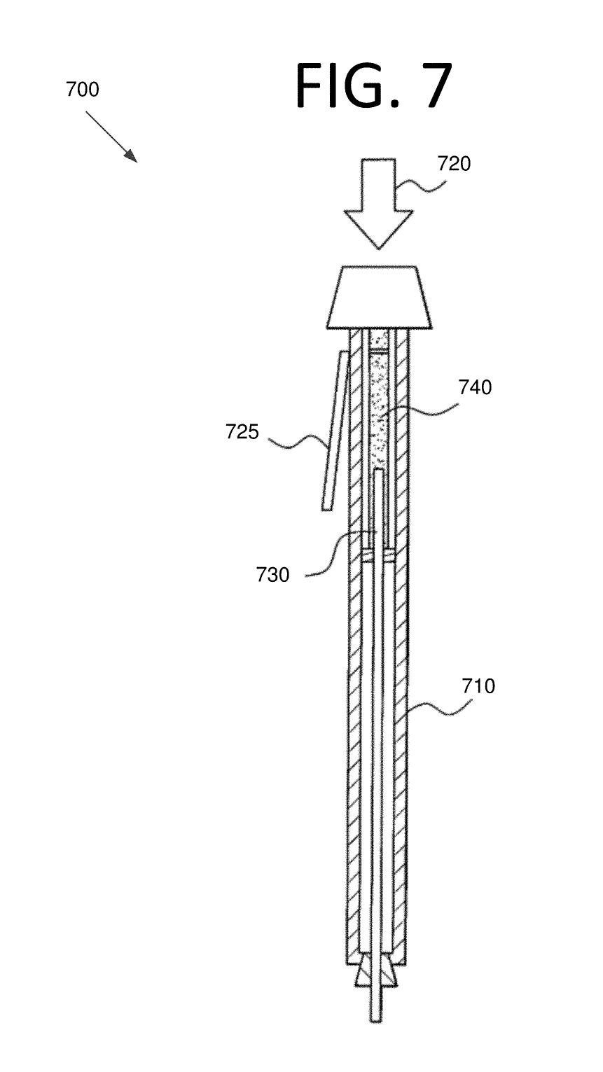

FIG. 8 is a perspective cutaway view illustrating a glow discharge plasma reactor 800, according to an embodiment of the present invention. Reactor 800 is configured as a glow discharge tube in this embodiment, including a housing 810 defining an inner chamber 820, which may contain pressurized deuterium, tritium, or any suitable fuel gas.

Housing 810 includes an insulator (e.g., glass, quartz, or ceramic material) and a pressure wall (e.g., metal or an alloy). A neutron reflector liner 830 is known to thermalize and/or reflect neutrons, thus increasing the probability of reactions within inner chamber 820. Neutron reflector liner 830 may be formed from beryllium or any other suitable material. As in a conventional glow discharge tube, anode 840 and cathode 850 are spaced apart within inner chamber 820. Applying a potential difference across anode 840 and cathode 850 generates a glow discharge plasma in the fuel gas that fills inner chamber 820. This gas may be under relatively low pressure in some embodiments, such as atmospheric pressure or less.

Unlike in a conventional glow discharge tube, in reactor 800, cathode 850 is formed from a material that is able to readily absorb and/or adsorb hydrogen isotopes in this embodiment, including, but not limited to, metal hydrides, lanthanides, actinides, ionic hydrides, covalent hydrides, intermediate hydrides, select metals known to be active (e.g., nickel, tungsten, rhenium, molybdenum, ruthenium, rhodium, etc.), hydrides thereof, alloys with non-hydriding materials (e.g., silver, copper, etc.), suspensions, and/or combinations thereof. Thus, the glow discharge plasma is generated proximate to cathode 850 and acts as source of energetic electrons on cathode 850 itself. Electrons accelerated away from cathode 850 collide with nuclei within inner chamber 820, generating X-rays. The X-rays, in turn, produce energetic electrons inside cathode 850 via the photoelectric effect or through Compton scattering. These energetic electrons participate in the deep screening and/or forced electron capture process with the high density hydrogen isotopes, converting them to their neutral, or effectively neutral, counterparts inside the molecular lattice of the material structure (i.e., molecules, compounds, etc.).

The surface of cathode 850 should be configured to produce a strong local electric field by using a corrugated cathode surface with sharp microstructure features or another suitable mechanism. In addition to forming cathode 850 from the material to be transformed, the material may be wrapped around cathode 850 or placed sufficiently near cathode 850 such that the material is impinged upon by the glow discharge plasma. By including the substrate material in and/or around cathode 850, cathode 850 and/or the substrate material may be easily removed and replaced. Any suitable type of heat exchanger 860 may be integrated into reactor 800 for removing usable energy from the reaction.

The fuel gas surrounds anode 840 and cathode 850, providing fuel to cause the reactions. Cathode 850 may be formed from any suitable type of hydride material and anode 840 may be made from either a hydride material or a non-hydride material. The material of cathode 850 may be hydrided in place with hydrogen isotopes having an atomic mass of at least two by the hydrogen isotope ions being accelerated through the plasma sheath into cathode 850, or may be hydrided separately prior to insertion into reactor 800. A high voltage power supply (DC, pulsed DC, or AC, not shown) is connected across anode 840 and cathode 850, providing voltages greater than 1500 V and currents of 1 mA or more in some embodiments.

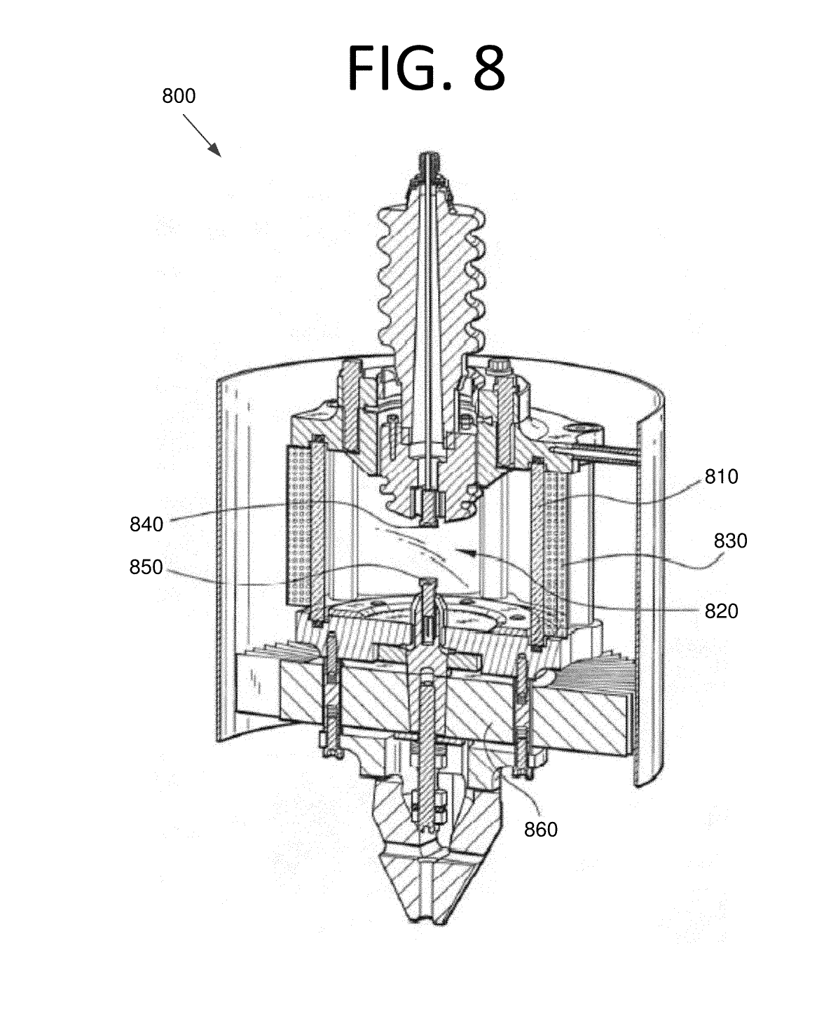

FIG. 9 is a side view illustrating a cathode 900 for a glow discharge plasma reactor, according to an embodiment of the present invention. For cathode 900, as well as for cathodes generally, during operation, a cathode plasma sheath 910 forms in close proximity to cathode 900. Within plasma cathode sheath 910, ionized fuel atoms (i.e., deuterium, tritium, etc.) are accelerated with high voltage through the plasma sheath into cathode 900.

By way of example, ionized D⁺ ions are accelerated through the sheath layer to create D-D reactions in the cathode. The D-D reactions create fast, energetic neutrons, protons, and deuterons. These fast neutrons, protons, and deuterons participate in (n, 2n), (p, 2n), or (d, 2n) reactions, respectively, in materials embedded in the cathode to multiply the neutron flux, thus increasing the desired effect. For instance, (n, 2n) means that for any neutron of a certain energy hitting the material, two neutrons will be liberated, which are able to promote further reactions in cathode 900. Similar processes occur when tritium is used as the fuel and would result in even higher output power.

Energetic electrons accelerate through plasma sheath 910 away from cathode 900 toward the anode. During this acceleration, X-rays are formed that emanate omnidirectionally 920, including back toward cathode 900. These X-rays cause either photoelectrons or Compton-scattered electrons to form in cathode 900. The electrons may have energies of 5 to 6 KeV or more. These energetic electrons create deeply screened or neutral nuclei, such as ₀²D or ₀³T, in cathode 910. The fuel ions hit cathode 900 with sufficient energy to cause D-D and D-T reactions. Also, the kinetic energy of the incoming ions will further increase mobility for the neutral and other particles to fuse with other fuel nuclei (neutral or charged) or with the cathode material itself, causing fusion and fission reactions. In both cases, large amounts of heat are released that may be extracted from cathode 900 by a heat exchanger or other suitable mechanism. Also during operation, neutrons will be generated and will interact with other types of nuclei. These nuclei will occupy excited states, emitting further energetic electrons or photons of sufficient energy to propagate further reactions.

In this embodiment, glow discharge cathode 900 includes a textured surface 902 to increase local field effects. This, in turn, causes more energetic electrons to leave cathode 900 through plasma sheath 910 to create more energetic X-rays in the plasma. Energetic X-rays 920 penetrate deeper into cathode 900, thus creating more neutral nuclei.

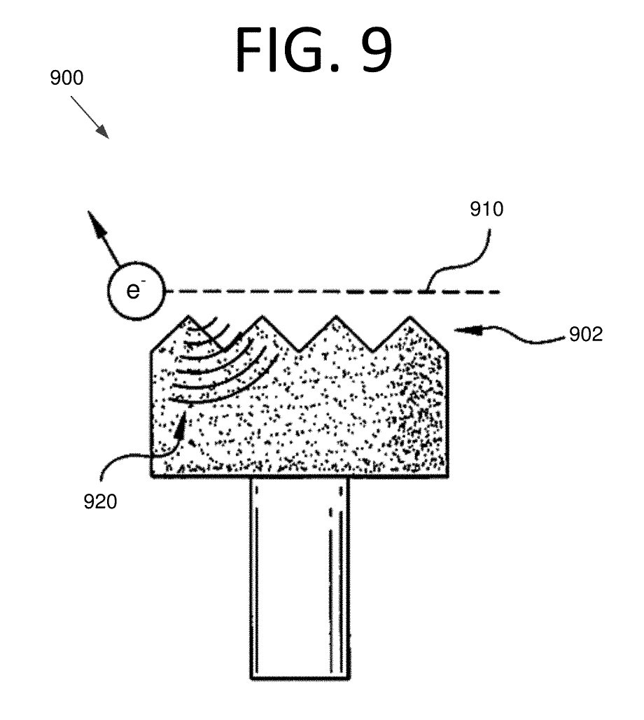

FIG. 10 is a side cutaway view illustrating a cathode 1000 for a glow discharge plasma reactor, according to an embodiment of the present invention. As with cathode 900 of FIG. 9, cathode 1000 also has a textured surface 1002 and causes a cathode plasma sheath 1010 to form. However, in this embodiment, cathode 1000 is formed from a composite 1004 of a hydrogen isotope absorbing and/or adsorbing material and other materials that will result in favorable nuclear reactions and higher rates of nuclear of reactions. For example, composite 1004 includes metal hydrides, lanthanides, actinides, ionic hydrides, covalent hydrides, intermediate hydrides, select metals known to be active (e.g., nickel, tungsten, rhenium, molybdenum, ruthenium, rhodium, etc.), hydrides thereof, alloys with non-hydriding materials (such as silver, copper, etc.), suspensions, and/or combinations thereof.

These materials may increase neutron numbers once the initial reactions (D-D or D-T) create the first generation of neutrons via the (n, 2n) process. Materials may also be embedded in cathode 1000 that offer special radioactive capture of thermal neutrons, such as (n, γ). Such materials would utilize thermal neutrons and result in additional beneficial effects, such as gamma energy that enhances the creation of electrons through the photoelectric effect, Compton scattering, or pair production, and metal converter materials (e.g., Ag, Rh, V, etc.), providing an additional source of energetic electrons. Both of the above provide energetic electrons that will create deeply screened and/or neutral nuclei in cathode 1000. Their reaction channels and energy released (Q), are given below:

₄₇¹⁰⁷Ag+₀¹n→₄₇¹⁰⁸Ag+γ(Q≈7.27 MeV) (7a)

₄₇¹⁰⁸Ag→₄₈¹⁰⁸Cd+e⁻+ν̅ₑ(Q≈1.65 MeV;τ=2.37 min) (7b)

₄₇¹⁰⁹Ag+₀¹n→₄₇¹¹⁰Ag+γ(Q≈6.81 MeV) (8a)

₄₇¹¹⁰Ag→₄₈¹¹⁰Cd+e⁻+ν̅ₑ(Q≈2.89 MeV ;τ=24.6 sec) (8b)

₄₅¹⁰³Rh+₀¹n→₄₅¹⁰⁴Rh+γ(Q≈7 MeV) (9a)

₄₅¹⁰⁴Rh→₄₆¹⁰⁴Pd+e⁻+ν̅ₑ(99.55%;Q≈2.44 MeV;τ=42.3 sec) (9b)

₄₅¹⁰⁴Rh→₄₄¹⁰⁴Ru+e⁺+νₑ(0.45%;Q≈1.14MeV;τ=42.3 sec) (9c)

₂₃⁵²V+₀¹n→₂₃⁵²V+γ(Q≈7.31 MeV) (10a)

₂₃⁵²V→₂₄⁵²Cr+e⁻+ν̅ₑ(Q≈3.98 MeV;τ=3.743 min) (10b)

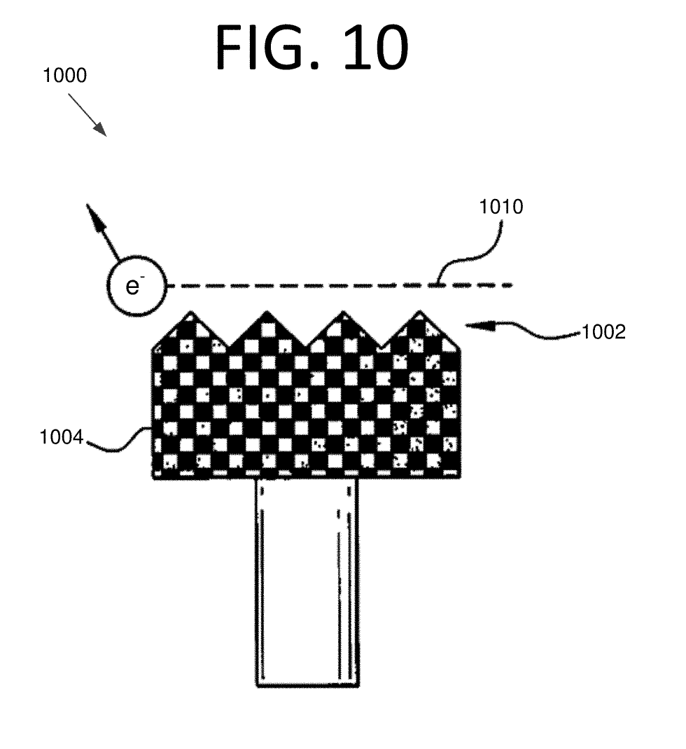

FIG. 11 is a side cutaway view of a cathode 1100 embedded within a jacket 1120, according to an embodiment of the present invention. Cathode 1100 is similar to cathodes 900 and 1000 of FIGS. 9 and 10, respectively, and operates in a similar manner within cathode sheath 1110. However, cathode 1100 is embedded within a jacket 1120 containing a high number density of hydrogen isotope fuel materials or other suitable fuel materials. These materials interact with the energetic neutrons caused by the reactions in cathode 1100, which are the same as those discussed above for cathodes 900 and 1000 (e.g., D-D or D-n and either forming other isotopes of hydrogen or thermalizing the neutrons not reacted in the cathode). Each of these processes results in greater thermal output. As described above, additional materials (i.e., metal converters) that perform the role of radioactive capture of thermal neutrons, converting thermal neutrons to energetic electrons, can be integrated with the high number density fuel materials in jacket 1120. In conditions where intense heating results, a flow of high number density materials can be used to both provide additional reactants via input flow 1140 and to carry away the intense nuclear heating via output flow 1150. A neutron reflector 1130 may be added to further reflect neutrons back into the reaction zone, thus making the process more efficient.

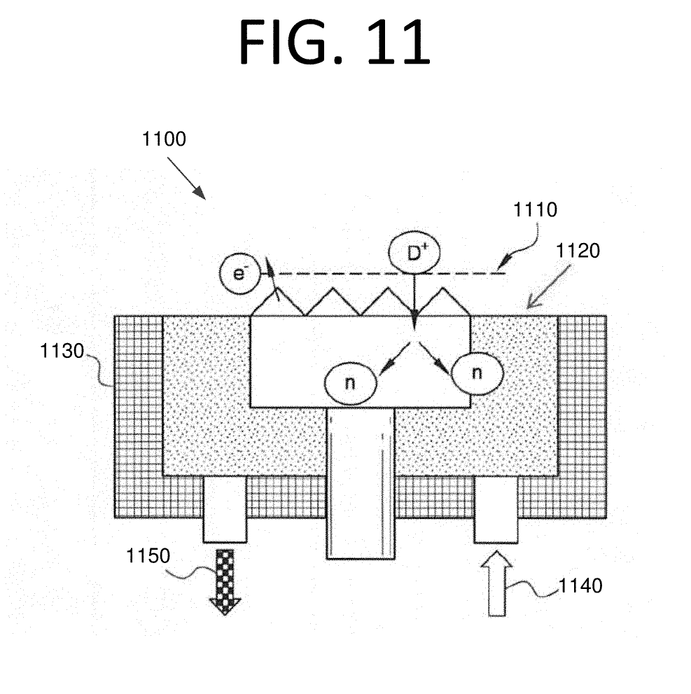

FIG. 12 is a side cutaway view illustrating a high pressure gamma plasma reactor 1200 with an integrated heat exchanger 1210, according to an embodiment of the present invention. Reactor 1200 includes a central core composed of integrated heat exchanger 1210, a high number density fuel source 1220, and optionally, a substrate material 1222 for nuclear transformation and transmutation. Fuel source 1220 may be formed from any suitable type of material that has a high number density with respect to loading with deuterium, tritium, or another fuel. As described above, such materials include metals, metal hydrides, deuterated hydrocarbons, etc. Fuel source 1220 may also be mixed with hydrided metals or other hydride materials, herein referred to as accelerants, chosen for their superior (n, 2n) performance to multiply neutrons.

As an example, fuel source 1220 may be further mixed with another material, such as ⁹Be (i.e., Be-9) that returns two neutrons when struck by neutrons of a threshold energy to intensify reactions. Also, materials such as Ag, Rh, V, etc., herein referred to as metal converters, may be included that have a high radiative capture cross section for thermal neutrons (n, γ) causing energetic gamma rays and/or energetic electron emissions to create additional deeply screened and/or neutral nuclei to internally enhance, propagate, or accelerate the reaction. In addition, materials such as ⁹Be or hydrogen isotopes may be included to participate in photodisintegration reactions to release fast neutrons and protons.

Reactor 1200 includes a reactor housing 1230 defining the inner chamber. Heaters (not shown) may be integrated with housing 1230 for startup operations. A cap 1232 seals one end of reactor housing 1230 with a central bore defined therethrough for projection of energetic photons 1240 in the form or gamma rays or X-rays. The other end of the reactor housing is closed, except for a high pressure connecting capillary 1234 for adding or removing reactants and products. A neutron reflector shield 1250 surrounds the reaction chamber to further reflect the neutrons backs into the chamber, thus intensifying the reaction kinetics. Such neutron reflective shields or sleeves are typically formed from beryllium or a material with similar properties.

High number density fuel source 1220 (i.e., a reactant gas) is compressed to high pressures (e.g., on the order of 1,500 atmospheres in some embodiments) to achieve a high number density. Another method of achieving a high number density incorporates a hydriding material, which can achieve very high number density (e.g., over 10²⁰ hydrogen isotope nuclei per cubic centimeter), which provides for a relatively high probability of nuclear reaction. The pressurized reactant gas is contained in pressure vessel (not shown), and may be heated by a pre-heater if such heating is necessary or beneficial for startup. The reaction is initiated by high-energy gamma rays or X-rays 1240. Reactor 1200 may be configured cylindrically, and may be wrapped with tubing of integrated heat exchanger 1210, through which working fluids remove excess heat and may be used externally to generate power or provide heat by an external system or device, as is done for conventional nuclear reactors. For example, thermal energy may be extracted/transferred by direct thermal conduction, radiative heat transfer, thermal convection, thermocouples, etc. Examples of such working fluids include, but are not limited to, atomic, molecular, ionic, and waste product solutions such as heavy water, liquid metals, deuterated silicon, and silane, as well as gases such as helium, deuterated methane, and deuterated ammonia.

During operation, incoming gamma rays or X-rays 1240 initiate fusion through the introduction of energetic electrons in the bulk that are generated by a photoelectric process or through Compton scattering to cause deeply screened and/or neutral nuclei to form. Additionally, photon energy could be used for photodisintegration of hydrogen isotopes and beryllium. This releases fast neutrons that cause kinetic heating of the fuel. This kinetic heating, in turn, causes D-D or D-T fusion with the release of energetic particles. These energetic particles interact with accelerants (e.g., in substrate material 1222), which may be a metal such as Ag, Th, U, Pd, etc.

During this process, heat energy is released, (n, 2n) reactions occur, and deeply screened and/or neutral nuclei may cause fission of moderate-Z materials (where “Z” represents the atomic number) for the release of large quantities of thermal energy. As noted above, fuel 1220 may be mixed with an additional material 1222 in the central core.

The deeply screened and/or neutral nuclei fuse with nuclei of a metallic crystal lattice having a first atomic mass associated therewith to form a material formed from an element having a second atomic mass associated therewith, the second atomic mass being greater than the first atomic mass. Again using palladium as an example material for substrate material 1222, the electrons created from the photon beam via the photoelectric effect, Compton scattering, and pair production cause deuterium contained within the initial palladium crystal lattice to at least partially transform into deeply screened and/or neutral nuclei, each having an atomic mass of two or greater. Because the deeply screened and/or neutral nuclei have no electric charge, there are many reactions with either other fuel elements or with the palladium rod that proceed with positive energy output.

Substrate material 1222 does not need to contain a solid continuous material in some embodiments. Rather, the substrate material may be provided in powdered or other forms. For example, tubes, ribbons, foils, nanoparticles, nanotubes, nanofoams, or thin films of the substrate material may also be formed and hydrided. The neutral particles may also fuse with isotopes of hydrogen that did not react with the metallic lattice of substrate material 1222, producing helium and other heavier materials, along with further energy release.

In addition to the transformation of materials and energy production described above, some embodiments may be used, for example, in the field of nuclear waste remediation. As an example, ₄₀⁹³Zr is one of the seven long-life radioactive products produced by conventional uranium fission reactions, with a half-life of 1.5 million years. The method of some embodiments may be used to convert ₄₀⁹³Zr into the stable ₄₀⁹²Zr in a matter of days with a recoverable energy release as a natural side effect of the fission decay process. In this example, the ₄₀⁹³Zr is hydrided, as described above, to absorb deuterium, tritium or a combination thereof, and is exposed to energetic electrons further enhance nuclear reactions in accordance with embodiments discussed herein. As a non-limiting example, a neutral deuterium nucleus may be created to generate the following decays and energy release (Q):

₄₀⁹³Zr+₀²D→₄₀⁹⁵Zr→₃₈⁹¹Sr+₂⁴He(Q≈7.24 MeV) (11)

₃₈⁹¹Sr→₃₉⁹¹Y+e⁻+ν̅ₑ(Q≈2.7MeV) (12)

₃₉⁹¹Y→₄₀⁹¹Zr+e⁻+ν̅ₑ(Q≈2.7 MeV) (13)

where the decay reaction (12) takes place over 9.63 hours and the decay reaction (13) leading to a stable Zr isotope takes place over 58.51 days. If one uses a neutral nucleus of atomic mass 3, rather than the ₀²D nucleus, the decay reaction is even faster. If one starts with a tritium nucleus (i.e., a triton) rather than a deuteron, a neutral nucleus of atomic mass 3 can be created (referred to herein as 8T). This forced electron capture process is similar to that described above for forced electron capture by the deuteron. Using the ₀³T nucleus, ₄₀⁹³Zr may be disposed of in a matter of hours:

₄₀⁹³Zr+₀³T→₄₀⁹⁶Zr→₃₈⁹²Sr+₂⁴He(Q≈8.28 MeV) (14)

₃₈⁹²Sr→₃₉⁹²Y+e⁻+ν̅ₑ(Q≈1.95 MeV) (15)

₃₉⁹²Y→₄₀⁹²Zr+e⁻+ν̅ₑ(Q≈3.64 MeV) (16)

where the decay of decay (15) takes place in approximately 2.66 hours and the decay of decay (16) takes place over approximately 3.54 hours.

In some embodiments, the electron source may be supplied by modified conventional medical x-ray equipment, for example. Conventionally, a medical x-ray machine is, in essence, a small LINAC that includes a vacuum tube. A stream of high energy electrons is directed by a cathode (i.e., an electron source) towards an anode (i.e., a braking target), both inside the vacuum tube. The anode is typically a small, thin strip of metal that includes a softer, less dense metal to carry away heat (e.g., copper) and a harder, denser metal to create x-rays (e.g., tungsten). As the energetic electrons bombard the anode, the electron flux causes x-rays to be released from the harder metal. The sample target is well downstream of the braking target, and is impacted by the emitted x-rays at some distance.

However, in some embodiments, the medical target itself, or other target to be transmuted, replaces and is used as the braking target. In certain embodiments, the target to be transmuted is not cooled by removing heat using a water jacket or oil, as is done in conventional medical x-ray devices. Rather, the kinetic heating that occurs as a result of the high energy electrons striking the target to be transmuted is used to increase the probability that deeply screened and/or neutral nuclei are produced. In certain embodiments, it may be desirable for the target to be transmuted to be molten to further increase this probability.

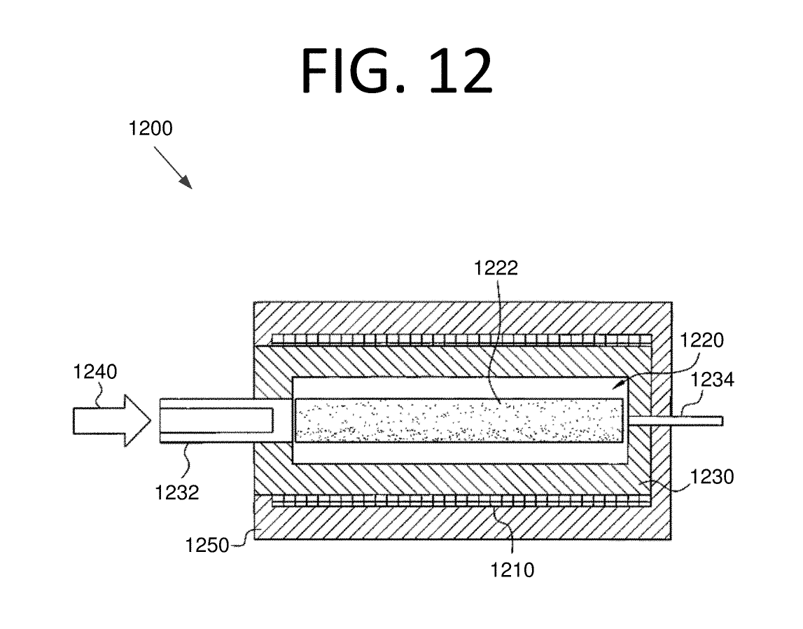

FIG. 13 is a side cutaway view illustrating an x-ray device 1300 with a target to be transmuted 1330 substituted for a braking target, according to an embodiment of the present invention. X-ray device 1300 includes a vacuum tube 1310 with a cathode 1312 that generates energetic electrons 1320 when a voltage is applied to cathode 1312. Energetic electrons 1320 impinge upon a deuterated target to be transmuted 1330, creating deeply screened and/or neutral nuclei.

In some embodiments, rather than replacing the braking target with the target to be transmuted, the target to be transmuted is placed in close proximity to the braking target (e.g., at a distance of less than one millimeter). This is done so as to create a specifically tailored electron and gamma flux. Essentially, a thin braking target converts some of the electron flux into gamma photons, but lets some of the electrons leak through to the target. This mixed energetic photon/electron beam could then directly provide a high flux of energetic electrons to the target that is adsorbed typically within few microns of the surface or more, while simultaneously provide deeply penetrating gamma photons, which then interact with the target and/or fuel to create localized additional energetic electrons.

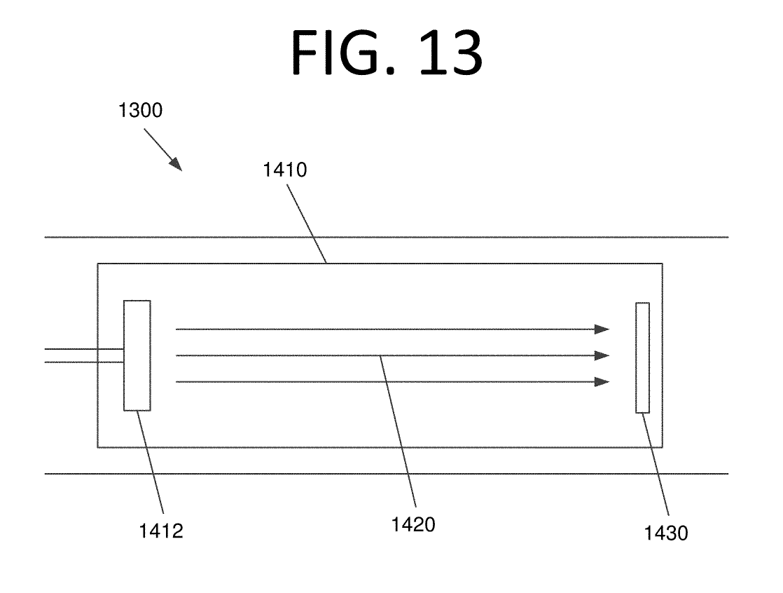

FIG. 14 is a side cutaway view illustrating an x-ray device 1400 with a target to be transmuted 1430 placed proximate to a braking target 1414, according to an embodiment of the present invention. Per the above, braking target 1414 is an anode. X-ray device 1400 includes a vacuum tube 1410 with a cathode 1412 that generates energetic electrons 1420 when a voltage is applied to cathode 1412. Energetic electrons 1420 impinge upon braking target 1414, creating X-rays and neutrons 1440. X-rays and neutrons 1440 then contact a deuterated target to be transmuted 1430, creating deeply screened and/or neutral nuclei.

An important advantage of some such embodiments that is not possible with conventional technologies is that medical isotopes or other transmuted materials may be created on site at a hospital or other facility. This allows for the production of medical isotopes and other materials that can be produced on demand and used rapidly after production. In the case of ⁹⁹Mo and ⁹⁹mTc discussed above, which have half-lives of 66 hours and 6 hours, respectively, this reduces the production and transportation costs, as well as the risks of exposure of various personnel to radiation during the transportation process. Additionally, it may no longer be necessary to perform chemical separation to obtain the radioisotope of interest.

Furthermore, it may be possible to generate radioisotopes that do not result from conventional fission or cyclotron processes, and/or have very short half-lives that are impractical or impossible to implement through conventional radioisotope supply chains. Such radioisotopes may have properties that are beneficial for certain treatments. To kill localized cancer cells, it may be beneficial to produce a radioisotope that is a strong alpha emitter with a very short half-life. For instance, if one could produce a strong alpha emitter radioisotope that has a half-life on the order of minutes, exposure of healthy cells to radiation would be greatly reduced. Similarly, a short half-life gamma emitter radioisotope may be used for imaging purposes, while reducing patient exposure to radiation by conventional ^{99m}Tc, for instance.

In some embodiments, the transformed material is capable of emitting energetic electrons or alpha particles upon fissioning, causing damage to nearby tissue. In some embodiments, the transformed material consists of deuterium chemically bound to elements capable of emitting energetic electrons or alpha particles upon fissioning. In some embodiments, the transformed material is further embedded within a delivery system capable of being incorporated within the general body circulation system, such as within a ferritin cage.

In some embodiments, the transformed material is capable of emitting gamma radiation or positron particles upon transformation. The transformed material may include, but is not limited to, ^{99m}Tc, ¹²³I, ²⁰¹Tl, ⁶⁷Ga, ¹⁸F, and/or ¹¹¹In. In certain embodiments, one or more of the list of known medical isotopes may be produced. In certain embodiments, emitted gamma radiation and/or positron particles are detected outside the body and are used for medical imaging applications.

In some embodiments, the transformed material includes deuterium chemically bound to elements capable of emitting gamma radiation or positron particles upon transformation. In certain embodiments, the transformed material is further incorporated within specific bodily tissue. In some embodiments, the incorporation is provided by an injection. In some embodiments, the transformed material is further bound to molecules that are preferentially incorporated within specific bodily tissue, such as a tumor. In certain embodiments, the molecule bound with the transformed material is a sugar.

Some embodiments may be “activated” within a patient. For instance, a target material to be transmuted may be introduced via ingestion (e.g., modified sugars containing the target material), via injection (e.g., a shot or IV), surgically inserted, or introduced to the body via any other suitable mechanism. The target material, which may be entirely benign initially, may then be “activated” by exposing the desired part of the body (e.g., via a pinpoint pulse), or the entire body, to energetic electrons, X-rays, etc. from a LINAC or some other source to further interact with a deuterium atom that, together with the target material and optionally also with delivery molecule (such as sugar or an antibody), may than used to initiate reactions according to some embodiments.

Once activated, the target material would emit the desired radiation (e.g., alpha particles, energetic electrons, gamma rays, etc.) depending on the treatment that is desired. For instance, alpha particles may be emitted by a radioisotope with a short half-life for pinpoint or body-wide cancer treatment, gamma rays may be emitted for imaging, etc. One particularly attractive use of some embodiments is that where sugars including the target materials are selected, these may be absorbed by cancer cells at a much higher rate than healthy cells. Even where cancer has metastasized, if the target has a short half-life and emits alpha particles, cancer cells may be damaged badly or killed in a short period of time while most of the healthy cells are relatively unaffected. This presents the opportunity to treat at least some advanced cancers that may otherwise have been untreatable via conventional methods. An X-ray device or a different LINAC may be all that is required to activate the target within the patient.

In addition to creating desired elements and isotopes, materials having particular properties could be readily manufactured by the approach of some embodiments, where selection of desired material properties could be tuned by varying the particular material making up the initial crystal lattice, varying the locations where the lattice is loaded with hydrogen isotope, varying the concentrations of tritium and deuterium in the isotope, varying the pressure of the isotope environment, and varying the characteristics of the energetic beam. As such, some embodiments may be used not only for transformation/transmutation of elemental composition, but also for modifying microstructures of materials, thus causing changes to material properties on both the microscopic and macroscopic scales. Additional customized transmutation could be achieved by starting with a particular lattice or microstructure configuration. As an example, using carbon nanotubes as the hydrating material could result in new materials with controllable properties.

As noted above, in order to increase the overall process probability, a very high density of the reacting hydrogen isotopes as nuclear fuel should be provided in some embodiments. This high density may be accomplished using a high pressure gas state within the reactor chamber, by hydriding the metal lattice with the isotope, or using high number density materials, such as deuterated polyethylene, deuterated silane, lithium aluminum deuteride, deuterated paraffin, and the like, with a combination of the above. Additionally, the mobility of the light nuclei participating in the nuclear fusion reactions is particularly important to increasing reaction rates in some embodiments. Mobility may be increased via elastic scattering in general, and/or via stochastic (i.e., kinetic) heating of the hydrogen isotopes resulting from elastic collision of energetic reaction products, including protons and neutrons, with additional reactants may result in a direct increase of the kinetic energy of the latter to enable subsequent reactions.

In some embodiments, photodisintegration and deep screening and/or neutral particle creation are combined to result in a highly efficient nuclear reaction process. In such a process, gamma photons with energies above the deuteron splitting barrier of 2.2 MeV cause direct production of neutrons and protons with MeV-level energies, while some of the energetic photons scatter from the fuel or from high-Z materials nearby to result in localized energetic electrons that could facilitate fusion using techniques of some embodiments. In a nuclear chain of events, energetic reaction products, such as protons, neutrons, and other nuclei, could enhance further reactions by scattering off nearby cold fuel nuclei, thus instantaneously providing sufficient kinetic energy to these nuclei that is well above energy levels required to initiate conventional hot fusion, further multiplying the overall reaction rate.

Tables 3 and 4 below show some example ways of achieving high number densities of the fuel to create conditions required for nuclear reactions. The broad categories include, but are not limited to, hydriding/deuteriding metals, raising deuterium gas pressure to high pressures, using deuterated hydrocarbons (in solid forms, liquid forms, or both), or any combination thereof. Additionally, the reaction vessel of some embodiments may be loaded cryogenically with liquid deuterium, sealed, and then brought back to room temperature, or alternatively, the reaction vessel may be loaded with solid or liquid deuterated hydrocarbons, or some other fuel, sealed, and then heated to cause the fuel to vaporize. It should be understood that deuterium is used solely as an example in Tables 3 and 4, since, as described above, tritium, a combination of tritium and deuterium, or other elements capable of similar behavior may also be utilized.

TABLE 3
MATERIALS PROVIDING A HIGH NUMBER
DENSITY OF DEUTERIUM FUEL

| | Density | Molar | #D/ | |
|---|---|---|---|---|
| Material | (g/cm³) | Mass | Molecule | # D/cm³ |
| Deuterium gas at | | | | |
| 0.174 g/cm³ | 0.174 | 4 | 2 | 5.24 × 10²² |
| 0.237 g/cm³ | 0.237 | 4 | 2 | 7.14 × 10²² |
| Deuterated Metals | | | | |
| D-Titanium (1:2) | 4.4 | 52 | 2 | 1.02 × 10²³ |
| D-Titanium (1:1.5) | 4.4 | 52 | 1.5 | 7.64 × 10²² |
| D-Zirconium | 5.72 | 94 | 2 | 7.33 × 10²² |
| D-Yttrium | 4.39 | 93 | 2 | 5.69 × 10²² |
| D-Scandium | 3.11 | 49 | 2 | 7.64 × 10²² |
| D-Erbium | 8.35 | 170 | 2 | 5.92 × 10²² |
| D-Uranium | 7.2 | 244 | 2 | 5.30 × 10²² |
| D-Uranium | 10 | 242 | 2 | 5.00 × 10²² |
| D-Tantalum | 3.8 | 185 | 2 | 2.50 × 10²² |
| Deuterated Hydrocarbons (solids) | | | | |
| Polyethylene | 0.95 | 16 | 2 | 7.15 × 10²² |
| Polystyrene | 1.05 | 112 | 8 | 4.52 × 10²² |
| Polybutadiene | 0.91 | 60 | 6 | 5.48 × 10²² |
| Deuterated Hydrocarbons (liquids) | | | | |
| Cyclohexane | 0.78 | 96 | 12 | 5.87 × 10²² |
| Polybutadiene | 0.89 | 1260 | 54 | 2.3 × 10²¹ |
| Acetone | 0.79 | 68 | 8 | 5.60 × 10²² |
| Dodecane | 0.75 | 196 | 26 | 5.99 × 10²² |
| Octadecane | 0.78 | 292 | 38 | 6.11 × 10²² |
| Heavy Water | 1.11 | 20.03 | 2 | 6.67 × 10²² |
| Lithium deuteride | 0.82 | 8.94 | 1 | 3.50 × 10²² |
| Lithium hydroxide LiOD | 1.5 | 24.955 | 1 | 3.60 × 10²² |
| Other | | | | |
| Silane SiD₄ (liq.) | 0.58 | 36.15 | 4 | 3.86 × 10²² |
| Sodium Borodeuteride (sol.) | 1.187 | 41.8 | 4 | 6.84 × 10²² |
| D-2-phenylpyridine (sol.) | 1.14 | 164 | 9 | 3.77 × 10²² |
| Lithium Aluminum Deuteride (sol.) | 0.736 | 41.98 | 4 | 4.22 × 10²² |
| Tris (2-phenylpyridine) | 0.7 | 679 | 24 | 1.50 × 10²² |
| Iridium | 0.48 | 20 | 4 | 5.78 × 10²² |
| D-methane (100 Mpa, 150° C.) (gas) | 0.41 | 20 | 4 | 5.17 × 10²² |
| D-methane (0.2 Mpa, −150° C.) (liq) | 0.7 | 20 | 3 | 6.30 × 10²² |
| Deuterated ammonia liquid −30° C. | 15.1 | 191 | 5 | 2.44 × 10²³ |
| Tantalum Petadeuteride | | | | |

TABLE 4
MATERIALS PROVIDING A HIGH NUMBER DENSITY
OF DEUTERIUM FUEL (CONTINUED)

| Material | Model |
|---|---|
| Deuterium gas at | |
| 0.174 g/cm³ | D₂ |
| 0.237 g/cm³ | D₂ |
| Deuterated Metals | |
| D-Titanium (1:2) | TiD₂ |
| D-Titanium (1:1.5) | TiD_{1.5} |
| D-Zirconium | ZrD₂ |
| D-Yttrium | YD₂ |
| D-Scandium | ScD₂ |
| D-Erbium | ErD₂ |
| D-Uranium | UD₃ |
| D-Uranium | UD₂ |
| D-Tantalum | TaD₂ |
| Deuterated Hydrocarbons (solids) | |
| Polyethylene | —CD₂- |
| Polystyrene | —C₈D₈- |
| Polybutadiene | —C₄D₆- |
| Deuterated Hydrocarbons (liquids) | |
| Cyclohexane | C₆D₁₂ |
| Polybutadiene | —C₉₆D₅₄- |
| Acetone | C₃D₈₀ |
| Dodecane | CD₃(CD₂)₁₀CD₃ |
| Octadecane | CD₃(CD₂)₁₆CD₃ |
| Heavy Water | D₂O |
| Lithium deuteride | LiD |
| Lithium hydroxide LiOD | D-Li—O |
| Other | |
| Silane SiD₄ (liq.) | SiD₄ |
| Sodium Borodeuteride (sol.) | NaBD₄ |
| D-2-phenylpyridine (sol.) | C₁₁D₉N |
| Lithium Aluminum Deuteride (sol.) | AlD₄Li |
| Tris (2-phenylpyridine) Iridium | C₃₃D₂₄N₃Ir |
| D-methane (100 Mpa, 150° C.) (g) | CD₄ |
| D-methane (0.2 Mpa, −150° C.) (liq) | CD₄ |
| Deuterated ammonia liquid (−30° C.) | ND₃ |
| Tantalum Petadeuteride | TaD₅ |

As indicated above, the fuels with a high number density (i.e., number of deuterium (D) atoms per volume) may be in the form of gases, liquids, or solids. Further, by switching the precursor hydrogen (atomic mass of one) with a hydrogen isotope with an atomic mass of at least two results in a selection of numerous candidate fuels from which to draw. Basic chemical processes may be used to optimize the attributes for a specific end application including, but not limited to, number density, ratio of hydrogen isotopes of atomic mass of at least two to hydrogen of atomic mass of one, combination with other materials providing additional benefits from a nuclear reaction standpoint (e.g., where close proximity with the fuel causes secondary and tertiary nuclear processes to occur), etc.

In addition to basic chemical formation of the precursor fuel, other combinatorial approaches may be used, such as physical placement of the fuel near certain elements to be transformed, the usage of the liquid state of fuel, or both. With regard to physical placement of the fuel near the elements to be transformed, as a non-limiting example, a solid form of a deuterated hydrocarbon may be positioned against, or laminated with, metals that are either non-hydrided or hydrided (e.g., Ti-D). In this example, the higher atomic mass number (higher-Z) material enhances the photoelectric effect of creating electrons of sufficient energy to facilitate screening, reactions, or both, through the deep screening and/or forced electron capture approaches described above.

With respect to the use of deuterated liquids, various applications are enabled including, but not limited to, dissolving or suspending particles of elements having other desired nuclear benefits to provide a uniform distribution of the second agent. For example, dissolving or suspending metals having desired nuclear properties (e.g., (n, 2n), (p, 2n), (d, 2n), etc.) may multiply the neutron production to increase reaction rate and energy release when supplied with the appropriate rate and energy of incoming electrons. These materials may include, but are not limited to, beryllium, molybdenum, tantalum, hafnium, etc.

Dissolving or suspending materials that have a large radioactive capture cross section (e.g., metal transformers) would utilize thermal neutrons and result in two additional beneficial effects: (1) gamma energy would enhance the creation of electrons through the photoelectric effect, Compton scattering, or pair production; and (2) metal transformer materials become energetic electron emitters, thus providing an additional source of energetic electrons. A small subset of these materials includes, but is not limited to, silver, rhodium, vanadium, and their corresponding compounds (e.g., silver nitrate) to facilitate solution or suspension. Use of liquid hydrocarbons also permits the supply of fuel in the form of high number density deuterium flowing through a reaction chamber where the reactions take place. The fuel can serve at least two useful functions: (1) energetic neutrons generated from processes described above would interact with the deuterated fuel, thus causing subsequent reactions and useful effects; and (2) the fuel may also be used to carry the intense heat to a heat exchanger where heat could be used directly, to drive a heat-to-electric process, or both. An example of such fluid from Tables 3 and 4 is deuterated silane, which would serve as a heat transfer fluid due to its high temperature capability and high heat capacity.

Dependent on the particular application of the above process, the particular choice of various hydrided materials may vary. It should be understood that any suitable material capable of absorbing and/or adsorbing hydrogen isotopes may be used including, but not limited to, the hydrided metals listed above or materials such as high number density deuterated polyethylene, deuterated silicon, or the like. It should be noted that the reaction could be considerably enhanced by including materials in the reaction environment with large reaction cross-sections for multiplication of reaction participants (e.g., (n, 2n), (p, 2n), (d, 2n), etc).

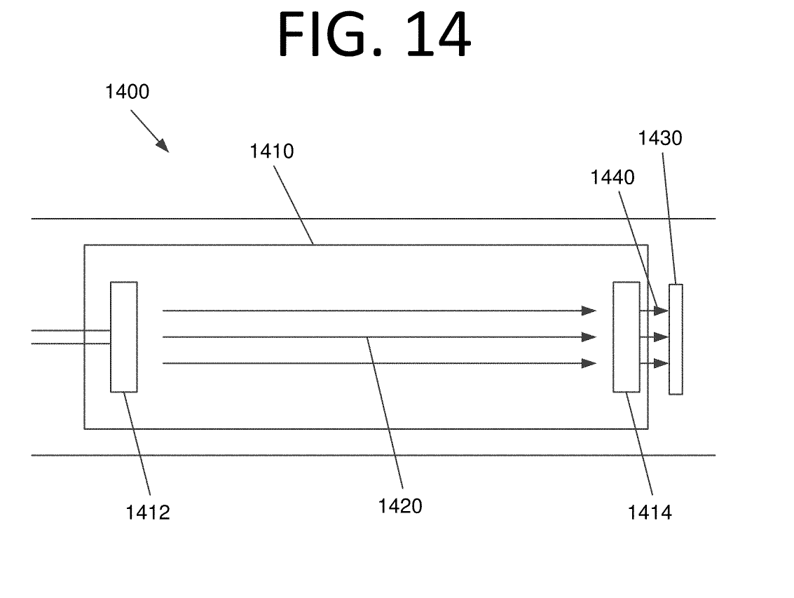

FIG. 15 is a side cutaway view illustrating a continuous fusion reactor 1500, according to an embodiment of the present invention. Reactor 1500 includes a central tube 1510, through which high number density fuel 1520 flows at a rate sufficient for maximum reaction rate efficiency in this embodiment. A photon source 1530 is directed along the central axis of tube 1510 to effectively utilize the energetic electrons caused by the photoelectric effect, Compton scattering, pair production, or a combination thereof. As the fuel 1520 flows through tube 1510, the energetic electrons interact with the high number density fuel (e.g., high pressure deuterium or tritium gas at pressures of at least 1,500 atmospheres in some embodiments), creating deeply screened and/or neutral nuclei that fuse together or with other nuclei.

During this process, significant nuclear heat is generated. Heat exchanger 1540 is positioned adjacent to central tube 1510, and is used to both cool the reaction chamber and convey nuclear heating to an external application, such as an electrical conversion device. Heat exchanger 1540 and central fuel tube 1510 are confined in a pressure vessel 1550, which may also include a heater (not shown) for reaction initiation. Alternatively, the working fluid in heat exchanger 1540 may initially increase the temperature to the desired reaction temperature. Additionally, a neutron absorbing jacket 1560 may be formed by filling the working fluid in heat exchanger 1540 with a material containing hydrogen isotopes (e.g., high pressure hydrogen isotopes or heavy water) to further thermalize neutrons, thus increasing process efficiency. A neutron reflector 1570 may further surround pressure vessel 1550 to reflect neutrons back into the reaction zone.

As described above, other materials that would be beneficial for (n, 2n) or metal converter processes may be mixed with the high number density fuel flow to intensify reaction kinetics. Multiple parallel reactors receiving photons from one or more photon sources, each having the same or a similar architecture to reactor 1510, may be stacked side-by-side to increase reactor efficiency and thermal output.

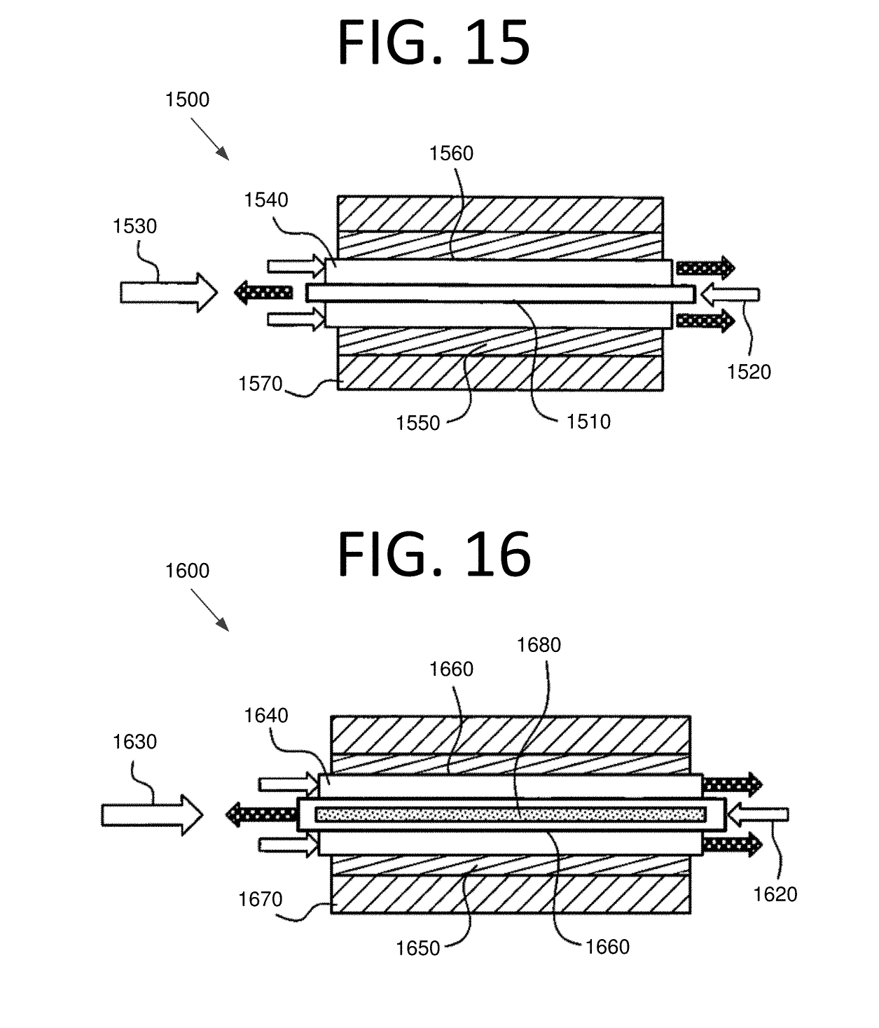

FIG. 16 is a side cutaway view illustrating a fusion-fission reactor 1600, according to an embodiment of the present invention. Similar to reactor 1500 of FIG. 15, reactor 1600 has a central tube 1610, a high number density fuel 1620, a photon source 1630, a heat exchanger 1640, a pressure vessel 1650, a neutron absorbing jacket 1660, and a neutron reflector 1670. However, unlike reactor 1500, a central core rod 1680 is positioned in the center of flowing fuel 1620 in reactor 1600. The material forming rod 1680 is chosen to cause photoelectrons to effect deeply screened and/or neutral nuclei formation within the material. The material for rod 1680 may be selected for maximum nuclear heating effect. High-Z materials that hydride will fission, as described above, and release additional heat.

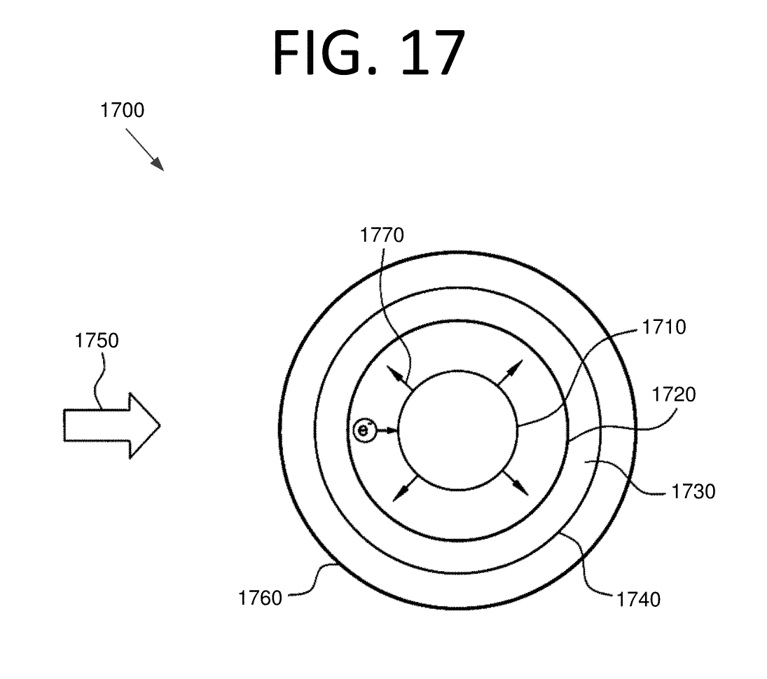

FIG. 17 is a front cutaway view of a fuel element 1700, according to an embodiment of the present invention. A high number density fuel forms a central core 1710 of fuel element 1700. Materials that may be used include, but are not limited to, deuterated polyethylene, polystyrene, silane, etc. Core 1710 may have other particles mixed in that may be either hydrided or non-hydrided, with an atomic mass of at least two. Central core 1710 is surrounded by a shell 1720 made from a material that yields (n, 2n) reactions, such as beryllium, in order to increase the neutron reaction rates and yield. A radially-adjacent layer 1730 surrounds shell 1720 and is formed from a material for thermalizing neutrons, such as standard polyethylene.

Additionally, a further layer 1740 formed from metal converter materials surrounds radially-adjacent layer 1730, resulting in energetic electrons that promote creation of additional deeply screened and/or neutral nuclei. The reaction processes are initiated by a supply of energetic neutrons. A photon energy source 1750 with energy of at least 65 kV may be used. As described above, photon source 1750 creates the energetic electrons via the photoelectric effect, Compton scattering, pair production, or any combination thereof. The materials in layers 1720 and 1740 also assist in converting the photons into useable energetic electrons. Further, an external neutron reflector 1760 may be provided that is formed from beryllium or another suitable material. Deeply screened and/or neutral nuclei 1770 are released as a result of the process.

As noted above, material transformation is not limited to an initial hydrided material in some embodiments. In the case of formation of deeply screened and/or neutral nuclei, they may be created for production of an energetic beam, which is then impinged upon a material to be transformed, which does not necessarily have to be hydrided. In this process, the deeply screened and/or neutral nuclei would interact with the nuclei of the material to be transformed directly, with the deeply screened and/or neutral nuclei being captured by the nuclei of the material to be transformed to create heavier nuclei, as in some embodiments discussed above. Any suitable material may be used in such a transformation process including, but not limited to, graphene, boron nitride, silicone, or molybdenum disulfide. As an example, graphene may be fused at thousands or millions of lattice nodes in some embodiments (out of trillions of nodes in the graphene structure) such that “holes” in the material are “blown” into the structure when a fusion reaction takes out “rows” of atoms in the lattice. These holes, generated by the fusion process, can then be used as new chemical bond sites for traditional chemical post-processing. Such post-processed structures could be used as material stock for subsequent assembly in a higher level product, such as a circuit board or another suitable application.

In addition to the processes stated above, the methods for transforming materials via nuclear processes can be used in conjunction with chemical processes. For instance, a material may be transformed first via a nuclear process then again via a chemical process to achieve a desired end state, or vice versa, or any combination of nuclear and chemical processes. Furthermore, certain material processes may include delaying subsequent nuclear or chemical processes to allow the initial nuclear process to decay to a final state prior to commencing with the subsequent process(es).

There are numerous possibilities for generating and producing materials having controlled, specialized properties and structures in some embodiments. As an example, such materials produced by the above-described methods could be used as security or encryption materials. In a non-limiting application, materials including a precise quantity, ratio, and/or precise pattern of one material, created by the above processes, embedded within another could be used as security markers or labels. For example, a radioisotope with reduced activity, or another relatively exotic (i.e., not easily obtainable) material, could be created in desired locations and/or in desired quantities and ratios within a base material, where the location, pattern, quantity, and/or ratio of the exotic material within the base material could be used for purposes of authentication, identification, or encryption. Unique decay rates of such materials could also be measured as a mechanism for identification and/or authentication.

A relatively simple modification made to a material using the above approach, for example, would be making a change to a node in a lattice structure such that the new atomic structure has either more or fewer electron bonds than it would under unmodified or conventional circumstances. For example, using the above approach, a carbon atom in a lattice could be transmuted to a nitrogen atom in the lattice, where the nitrogen is not able to share electron pairs with all four of the previous partners to the original carbon because nitrogen tends to share only three pairs of electrons. Since the new configuration would leave one bond unsatisfied, the properties of the lattice would be changed. Although such local changes may be made, typically on an atom-by-atom basis through conventional processes, if a larger number of bond pairs are needed by the new lattice node, such unbound configurations cannot be presently achieved by conventional chemical processes.

As a further example, an even more complex configuration can be induced if the new node is a noble gas, where no pairing is possible. Such a configuration could not be made by conventional processes and could only be produced using embodiments of the present invention. It should be noted that these new lattices, with node “defects” induced by a fusion, are forced to exist in this new state unless the node is released by a state change (e.g., where the solid is melted and the bonds are destroyed). These nodes with unbound electrons can cause unusual state conditions, particularly if, as noted above, the solid is hosting a noble gas atom. Such additions of noble gas atoms could lead to the production of multi-state matter.

A further level of complexity occurs when these unbound nodes are involved in any type of energy transport, such as through phonons, photons, or electrons. The properties of matter define these transports and the unique nodes within the lattice structure will create changes in these properties. Using the above method, such fusion-induced changes could be made, either randomly or in a specifically ordered fashion. Additionally, these induced changes may be coupled to external fields or forces.

Very complex configurations and situations can be induced by more elaborate fusion/fission events at lattice nodes. For example, a fission daughter product taking the location previously occupied by the parent could result in another daughter being isolated with the lattice as an unbound “caged” atom. Such “caged” or “trapped” atoms could give rise to new photon or electron transport layers. Phonon responses for the lattice may include the additional atom, which is not in a lattice node but, rather, in the lattice itself. A close similarity occurs with metal hydrides, where the gas occupies the space in between lattice nodes.

As a further example, the above method may be applied to the manufacture of magnetic materials. It is known that metals which are not typically magnetic can be made magnetic through creation of a strained lattice. Some embodiments could be used to produce a strained lattice, thus converting non-magnetic metals into magnetic materials. Conversely, lattices where atoms are removed by fusion induced by some embodiments, without a subsequent fission, have potential applications for stress relief, particularly in the stoppage of crack propagation. Materials can be transformed and/or transmuted to add or subtract phonon, photon, and electron mobility as desired.

One potential application for such manufactured magnetic materials is in the field of motors. High performance motors using materials that have been made to be magnetic by lattice strains may have unique properties, such as, for example, relatively light weights, since the new materials may be able to replace conventional dense metal coils and windings. Other unique properties may include higher temperature magnetic materials made of high temperature (e.g., refractory) metals that otherwise would be non-magnetic. These would enable unique higher temperature permanent magnet motors having very power density. Micro-motors designed to be activated (i.e., lattice strain inducement moment) after being built into a design (manufactured by 3-D printers or the like) could be relatively easily implemented. Additional motor applications include self-regulating motors, where increased current generates localized heating, which further enhances the lattice strain (i.e., a positive feedback process) such that motor current decreases. Such controls may eliminate some motor failure mechanisms.

Electromagnetic (EM) fields may also be generated (with included fluctuations) using distributed sources or a continuous source made from materials with strained lattice structures. Many smaller sources allow for large EM fields with discontinuities at a “joint” in a mechanism (e.g., in an exoskeleton). EM fields can transfer loads otherwise forced through the host inside the exoskeleton. Unlike a robot with joints under mechanical contact, these EM fields can effectively be enhanced as needed to bear increasing loads. Such a technique is not limited to exoskeletons, but could be applied to, for example, functional structures, such as bridges.

As another example, transparent metals (e.g., transparent aluminum) could be manufactured from a variety of combinations of processes, once the fundamental merger of metal strength and optical properties is completed. 3-D printing of alternate layers of metal with optical carriers is presently known, where the assembly limitations, such as melting temperature differentials, are overcome by building the structures layer-by-layer. Fusion and fusion/fission by some embodiments may be utilized as a source of localized heating, and the lattice parameters may be selected such that an optical wavelength is carried. Various strained lattice modes may also enable various degrees of magnetism. Since two superimposed lattice structures would be operating at the same time in some embodiments, sharing the same space, each would bring characteristics to the merger, resulting in simultaneous properties of dissimilar matter.

Most conventional optical systems are silicon-based. Silicon behaves much like carbon, and almost any structure that can be made with hydrocarbons can also be performed with a silicon analog. As deuterated hydrocarbons may be used in some embodiments, deuterated silicon analogs to hydrocarbons may also be applied. Hardened steel, for example, is treated with carbon atoms. In a fusion energy-sourced environment, annealing processes may be highly localized and silicon could be used to bring an optical aspect to the merged compound (i.e., producing a strong metal capable of photon transport). The particular metal properties and specific photon wavelengths may be tailored as desired. Photon transport is band gap-based, thus the band gaps of the lattice's “caged” atoms (which can be excited without an excitation of the lattice nodes themselves) may be used as the photon transport channel. One application of such “transparent metals” would involve embedded sensors in the metal-photonic structures, which may sense at a wide bandwidth, even if only a portion of the sensed wavelengths can be transmitted without a transform. If the superimposed lattices (i.e., metal and photonic carrier lattices) allow for light in the red and infrared wavelengths, but other visible wavelengths are blocked, then the available carrier wavelengths could transmit data. Smart materials of this nature could be manufactured through the building of such superimposed lattices.

Another example application is the manufacture of computer components. Silicon and carbon are presently the two leading candidates for almost every component in advanced computer architectures. However, these two elements form the basis of extensive hydrogen-centric compounds, including deuterated versions thereof. Using the superimposed lattices (and lattice properties) described above, photon-based computing, as well as co-processing using electrons and photons in different pathways in a lattice, could be performed using materials as described above. Additionally, two-dimensional carbon and silicon structures are well-known, and these could be transformed into circuit card equivalents with fusion processes that destroy some bonds (i.e., the fusion energy liberates a local cluster of atoms). These modified two-dimensional sheets would function much like a conventional circuit board, but at the individual atom level of integration. Chemical processes could further add molecules (i.e., circuitry functionaries) at the “damaged” nodes. Layered into multi-level circuits, these may be very fast and very small compared to any present conventional circuits. Additional nanoscale applications may allow for rapid advances in computer components, such as processors and memory chips.

Another potential application is in the field of spintronics. Spintronics involves advancement of data density using spin from a single atom to store information, which is highly desirable when compared with the thousands of atomic electrons currently required to store a bit of information in conventional memory. For spintronics to work, a single atom should be isolated and localized magnetic states of this atom should be controlled to “read” and “write” information in the magnetic spin. This is impossible using conventional materials and technology. Some embodiments, however, allow for realistic techniques for magnetic control over small clusters of atoms.

Although present spintronic researchers have built small clusters of atoms, the choices of material thus far have not been magnetic. Building blocks in the nanometer domain are still required. However, in some embodiments, several of the carbon and silicon nanometer-class building blocks could be altered by fusion/fission reactions to produce build-stock, which could then be subsequently chemically processed. Alternatively, the build-block could be a nearly two-dimensional molecule, such as MoS₂. These two-dimensional and nearly two-dimensional molecular structures typically have very unusual properties and characteristics, including unique electron mobilities. Once a structural break is created, the uniformity in that characteristic can be modified. The approaches of some embodiments could be used to produce those breaks and also liberate more energy in quantities sufficient to keep the process going as long as necessary. Thus, both energy and stock materials for future processing may be made with one reaction. The coupling (or building) of layers of fast electron transport with intersections having slower electron transport from these stock materials may involve using a chemical step to attach molecules at the break locations. At a superficial level, the original building block is like a metal sheet with extremely fast electron transport. The fusion reaction creates mechanical holes with edge atoms available for attachment via a traditional chemical bond process. These chemical bonds can be bonded to two building blocks (i.e., in a layered structure form). Some bonding is performed for the purpose of having EM control over the movement of the building block, whereas other bonding takes place to perform interconnections.

### Experimental Example 1

In this example, it is demonstrated that nuclear events result from X-ray irradiation of deuterated materials using processes according to some embodiments of invention. Titanium deuteride (TiD₂) plus deuterated polyethylene (DPE), DPE alone, and for control, hydrogen-based polyethylene (HPE) samples and non-deuterated titanium samples were exposed to X-ray irradiation. These samples were exposed to various energy levels from 65 to 280 kV with a prescribed electron flux impinging on the tungsten braking target from 500 to 9000 μA and total exposure times ranging from 55 to 280 minutes. Alpha and beta activities were measured using a gas proportional counter, and for select samples, beta activity was measured with a liquid scintillator spectrometer. The majority of the deuterated materials subjected to the microfocus X-ray irradiation exhibited post-exposure beta activity above background, and several showed short-lived alpha activity. For control purposes, hydrogen-based polyethylene (HPE) was also examined, as were unloaded Ti powders. Scans of as-received materials were completed to document alpha and beta activity rates before exposure. Materials were shown to have no alpha or beta activity above the minimum detectable amount (MDA) before exposing them to the X-ray beam.

Control Tests: Five different control tests were performed with HPE samples (no deuterium fuel) that showed no post-test alpha or beta activity above the MDA after being exposed to the X-ray beam protocol. In another control test, a combination of DPE and TiD₂ particles were loaded into a holding fixture and placed in the X-ray laboratory, but the beam was not energized. As expected, the test showed no alpha or beta activity above MDA. Yet another control test examined whether placing Ti powders (without deuterium loading) in the holding fixture and exposing the Ti powders to the ionizing X-ray beam would result in activation. That test also showed no alpha or beta activity above MDA.

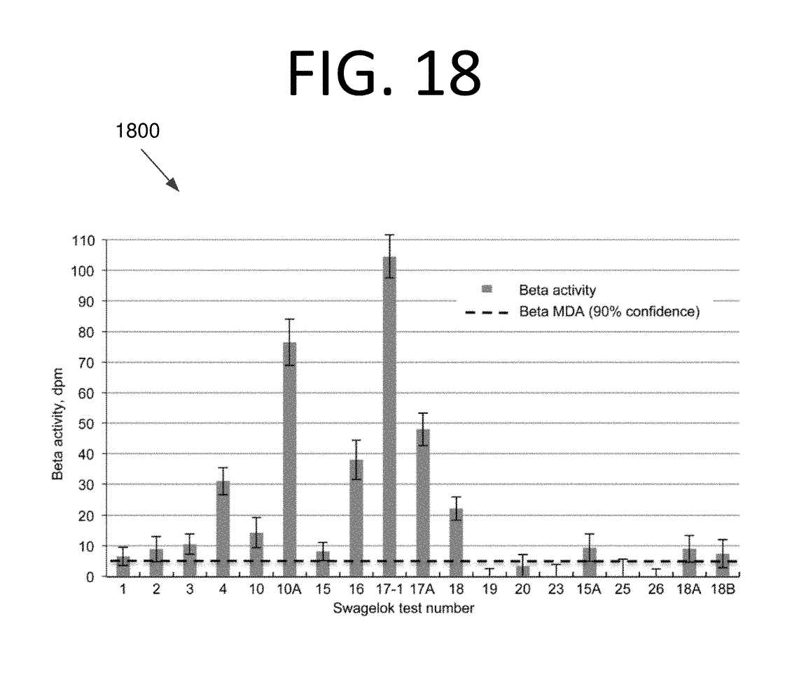

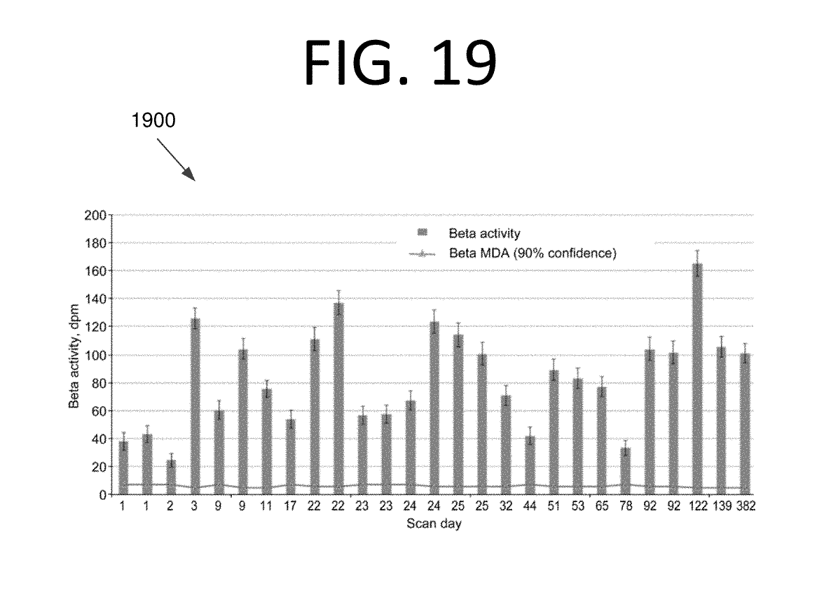

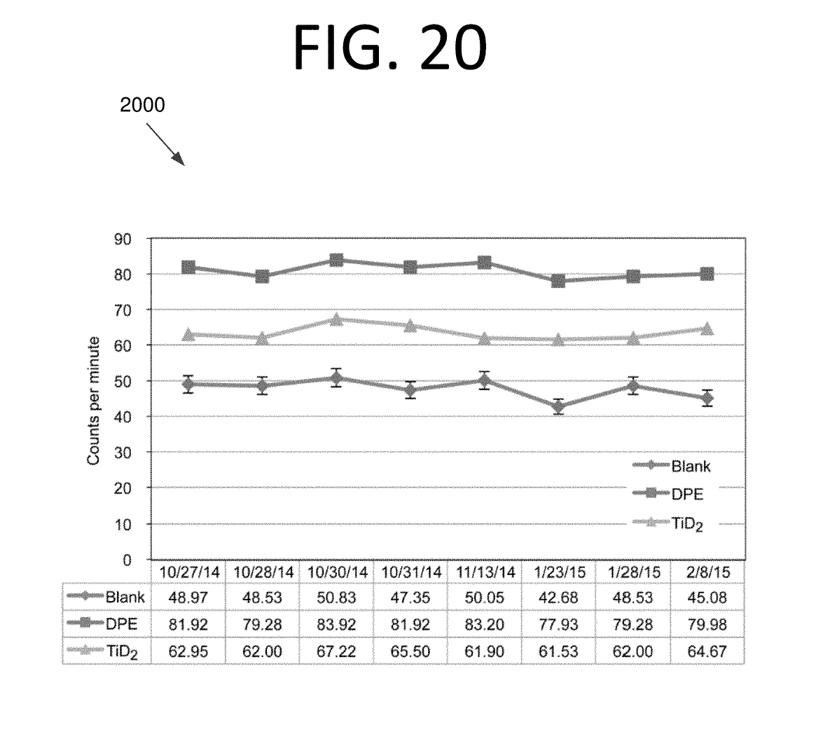

DPE and TiD₂ Tests: Two tests performed with DPE alone showed beta activity above background. TiD₂ mixed with DPE samples were the most active in regards to beta activity. Fourteen tests out of 19 total runs in this test sequence with either DPE or a DPE+TiD₂ mix were beta activated. See graph 1800 of FIG. 18. Some samples exhibited alphas, which decayed below MDA in approximately an hour following x-ray exposure. Several of the DPE+TiD₂ mixed samples showed persistent—beta activity. Several of the samples (designated as SL10A, SL16, and SL17A) showed beta activity above background with a greater than 4 sigma confidence level for months after exposure. See graph 1900 of FIG. 19. Portions of SL10A, SL16, and SL17A were scanned using a beta scintillator and found to have beta counts in the tritium energy band, continuing without noticeable decay for over twelve months. See graph 2000 of FIG. 20. Beta scintillation investigation of as-received materials (before X-ray exposure) showed no beta counts in the tritium energy band, indicating the beta emitters were not in the starting materials. As noted, in this test sequence five of the fixtures containing the DPE+TiD₂ mix were not beta activated after x-ray exposure. The underlying reason is not presently clear, with insufficient loading of deuterium in the material and other possible material factors.

### Experimental Example 2

This example demonstrates that nuclear activation and generation of nuclear isotopes including medical isotopes is possible using methods and apparatus described in the instant invention. Exposure of highly deuterated materials to a low-energy (nominal 2 MeV, below the photodisintegration limit for deuterium) photon beam from a LINAC resulted in nuclear activity of both the parent metals of hafnium and erbium and a witness material (molybdenum) mixed with the deuterated reactants (deuterated paraffin, D-para, and deuterated metals of Er, Mo, and Hf). Gamma spectral analysis of all deuterated materials ErD_{2.8}+D-para+Mo and all HfD₂+D-para+Mo showed that nuclear processes had occurred as shown by unique gamma signatures. For the deuterated erbium specimens, post-test gamma spectra showed evidence of unstable isotopes of erbium (¹⁶³Er and ¹⁷¹Er) and of molybdenum (⁹⁹Mo and ¹⁰¹Mo) and by beta decay, technetium (⁹⁹mTc and ¹⁰¹Tc). For the deuterated hafnium specimens, post-test gamma spectra showed evidence of unstable isotopes of hafnium (^{180m}Hf and ¹⁸¹Hf) and molybdenum (⁹⁹Mo and ¹⁰¹Mo), and by beta decay, technetium (^{99m}Tc and ¹⁰¹Tc). In contrast, when either the hydrogenated paraffin or non-gas-loaded erbium or hafnium materials were exposed to the gamma flux, the gamma spectra revealed no new isotopes. Neutron activation materials showed evidence of thermal, epithermal, and fast neutrons. The activation of ^{115m}In indicates fast neutrons, at least above the activation threshold of 336 keV. When considering cross sections for activation, the ^{115m}In findings point toward neutrons in the MeV range. No conventional sources of neutrons have been identified as the beam was controlled to less than the photodissociation of deuterium.

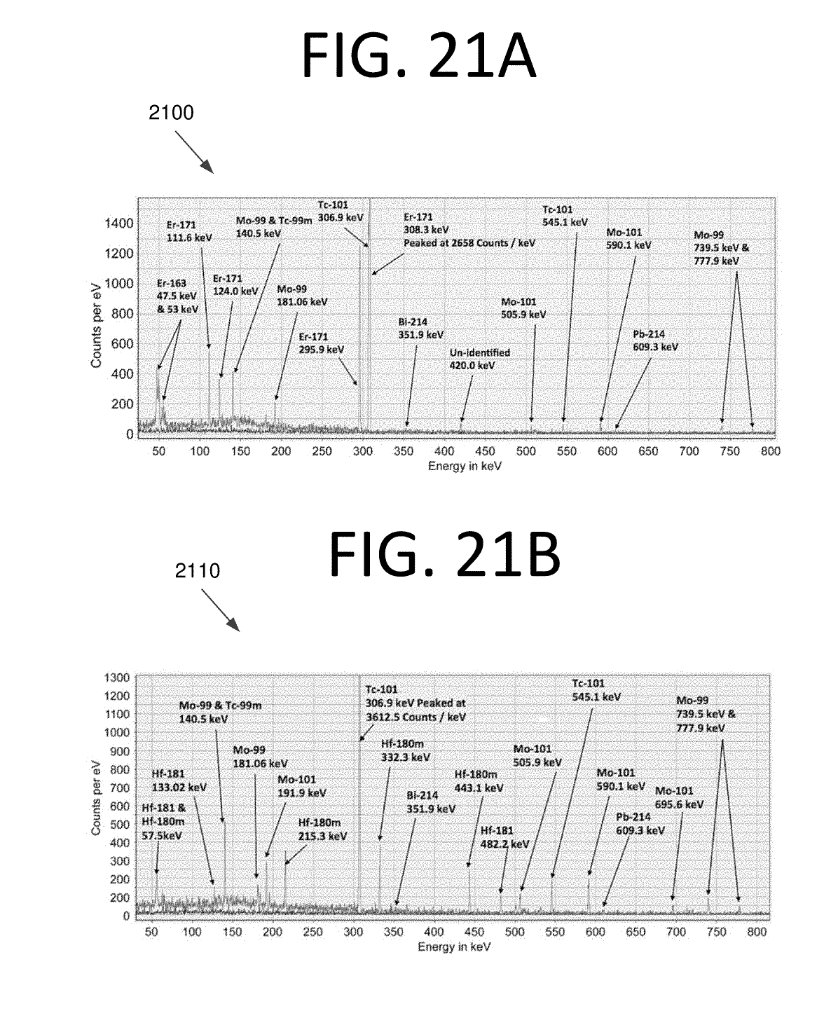

Gamma Spectrum: Gamma spectral analysis of all six of the deuterated materials ErDₓ+D-para+Mo and the HfD₂+D-para+Mo materials showed that nuclear processes had occurred during exposure as shown by unique gamma signatures. See graphs 2100 and 2110 of FIGS. 21A and 21B. For the deuterated erbium specimens, post-test gamma spectra showed evidence of unstable isotopes of erbium (¹⁶³Er and ¹⁷¹Er) and molybdenum (⁹⁹Mo and ¹⁰¹Mo), and by beta decay, technetium (^{99m}Tc and ¹⁰¹Tc). For the deuterated hafnium specimens, post-test gamma spectra showed evidence of unstable isotopes of hafnium (^{180m}Hf and ¹⁸¹Hf) and of molybdenum (⁹⁹Mo and ¹⁰¹Mo), and by beta decay, technetium (^{99m}Tc and ¹⁰¹Tc). In contrast, when either the hydrogenated or non-gas-loaded erbium or hafnium materials were exposed to the gamma flux, the gamma spectra revealed no new isotopes. The gamma spectra peaks showed only background decay lines. Although neutron activity appears to have occurred in deuterated materials, no conventional sources of neutrons have been identified.

Alpha/Beta Results: Alpha/beta counting showed no activity above background prior to exposure. However, the deuterated samples all exhibited net counts of beta activity multiple times background (5× to 190× background) after exposure. The hydrogenated samples showed no activity above background after exposure.

Neutron Energy: When deuterated materials were exposed, neutron activity was observed. The cadmium and gadolinium witness materials (placed in vials adjacent to the primary vials) showed evidence of thermal energy neutrons. The bubble detector dosimeters showed clear evidence that when deuterated specimens were exposed to the beam, a significant flux of neutrons were created in the >100- to 200-keV energy range. Solid-state CR-39 polycarbonate neutron detectors placed above the LINAC head showed clear evidence of fast neutrons during fueled shots. Using accepted techniques, the CR-39 detectors recorded neutrons with energy greater than 144 KeV and in some fueled experiments recorded triple tracks (10 MeV energy). The activation of ^{115m}In indicates fast neutrons, at least above the activation threshold of 336 KeV. When considering cross sections for activation, the ^{115m}In findings point toward neutrons in the MeV range.

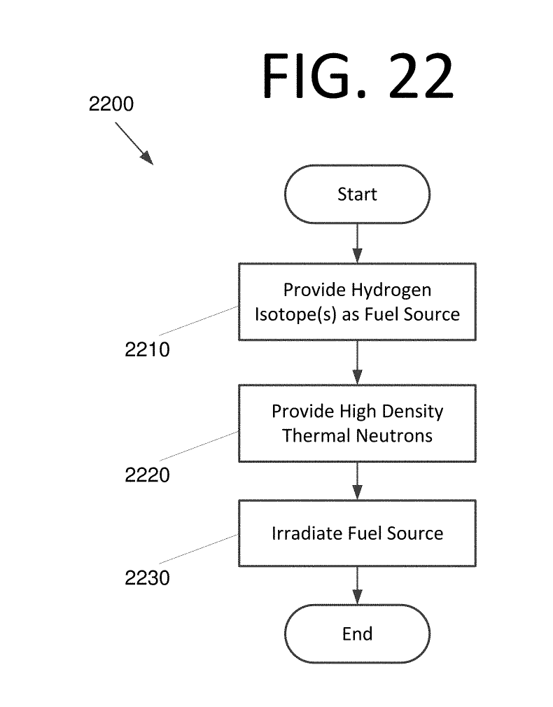

FIG. 22 is a flowchart illustrating a process 2200 for providing enhanced nuclear reactions, according to an embodiment of the present invention. The process begins with providing a sufficient density of one or more hydrogen isotopes in the form of deuterium and/or tritium gas, a deuterated or tritated liquid, a deuterated or tritated solid, a plasma, or any combination thereof as a fuel source in a reaction volume at 2210. High density neutrons with a total energy of 3 MeV or less are provided at 2220. Interaction between the neutrons with the total energy of 3 MeV or less forms neutral nuclei, facilitating nuclear reactions.

The fuel source is irradiated with a photon beam, a direct electron beam, or both, to produce energetic electrons at 2230. The fuel source is in a liquid or solid state at room temperature, the fuel source is loaded cryogenically as a liquid, one or more high-Z materials capable of donating electrons and/or neutrons are provided in the reaction volume, materials capable of being fissioned or being fertile are provided in the reaction volume, materials capable of producing multiplication events are provided in the reaction volume, electric fields are provided in the reaction volume, magnetic fields are provided in the reaction volume, one or more materials to be transmuted are provided in the reaction volume, one or more materials to moderate and/or reflect back neutrons leaving the reaction volume are provided, or any combination thereof. The energetic electrons created by the irradiating of the fuel source and/or the one or more high-Z materials cause at least some nuclei of atoms of the fuel source to become deeply screened for a period of time and/or to become neutral nuclei, facilitating nuclear fusion.

In some embodiments, when there are two reacting neutrons, one reacting neutron is at rest while the other reacting neutron has an energy of approximately 3 MeV or less. In certain embodiments, when there are two reacting neutrons, the combined energy of the reacting neutrons is approximately 3 MeV or less. In some embodiments, when there are two reacting neutrons, one of the reacting neutrons is at rest, and the other reacting neutron is produced at a desired energy level by a photodistintegration of a deuteron due caused by a photon beam corresponding to formation of the reacting neutron with the desired energy level. In certain embodiments, when there are two reacting neutrons, at least one of the reacting neutrons is produced by nuclear events.

In some embodiments, the one or more high-Z materials include a powder, nanoparticles, materials capable of donating electrons and neutrons to nuclear activation processes, or any combination thereof. In certain embodiments, the materials capable of producing multiplication events produce (n,2n) multiplication events, (n,3n) multiplication events, or both. In some embodiments, the plasma includes a glow discharge plasma, a hot plasma, a two-temperature plasma that is provided such that an ion temperature is colder than an electron temperature and the electron temperature is hotter than the ion temperature, or any combination thereof.

In some embodiments, the photon beam comprises X-rays, gamma rays, or both. In certain embodiments, the irradiating of the fuel source with the photon beam causes production of delocalized energetic electrons following a photoelectron process, a Compton process, an electron-positron pair production process, or any combination thereof. In some embodiments, the fuel source comprises at least one deuterated metal. In certain embodiments, an energy of the energetic electrons is less than 2.2 MeV.

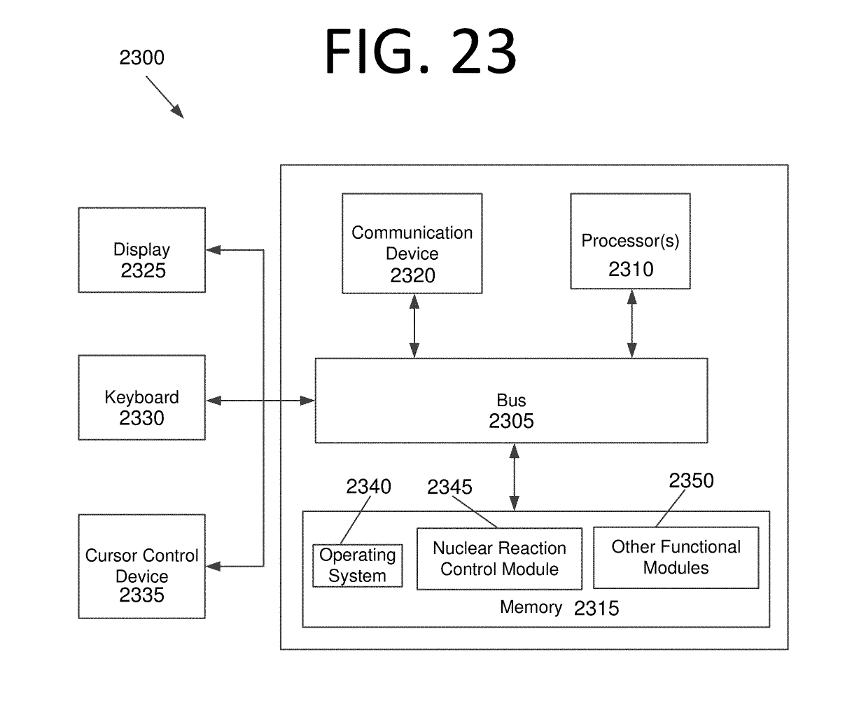

FIG. 23 is a block diagram illustrating a computing system 2300 configured to control a nuclear reactor, an x-ray device, or any other device or machine disclosed herein, according to an embodiment of the present invention. Computing system 2300 includes a bus 2305 or other communication mechanism for communicating information, and processor(s) 2310 coupled to bus 2305 for processing information. Processor(s) 2310 may be any type of general or specific purpose processor, including a central processing unit (“CPU”) or application specific integrated circuit (“ASIC”). Processor(s) 2310 may also have multiple processing cores, and at least some of the cores may be configured to perform specific functions. Multi-parallel processing may be used in some embodiments. Computing system 2300 further includes a memory 2315 for storing information and instructions to be executed by processor(s) 2310. Memory 2315 can be comprised of any combination of random access memory (RAM), read only memory (ROM), flash memory, cache, static storage such as a magnetic or optical disk, or any other types of non-transitory computer-readable media or combinations thereof. Additionally, computing system 2300 includes a communication device 2320, such as a transceiver and antenna, to wirelessly provide access to a communications network.

Non-transitory computer-readable media may be any available media that can be accessed by processor(s) 2310 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 2310 are further coupled via bus 2305 to a display 2325, such as a Liquid Crystal Display (LCD), for displaying information to a user. A keyboard 2330 and a cursor control device 2335, such as a computer mouse, are further coupled to bus 2305 to enable a user to interface with computing system. However, in certain embodiments such as those for mobile computing implementations, a physical keyboard and mouse may not be present, and the user may interact with the device solely through display 2325 and/or a touchpad (not shown). Any type and combination of input devices may be used as a matter of design choice.

Memory 2315 stores software modules that provide functionality when executed by processor(s) 2310. The modules include an operating system 2340 for computing system 2300. The modules further include a nuclear reaction control module 2345 that is configured to operation nuclear reactors, X-ray devices, and/or any of the other devices and systems discussed herein, or derivatives thereof. Computing system 2300 may include one or more additional functional modules 2350 that include additional functionality.

One skilled in the art will appreciate that a “system” could be embodied as an embedded computing system, a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
providing a sufficient density of one or more hydrogen isotopes in the form of deuterium and/or tritium gas, a deuterated or tritated liquid, a deuterated or tritated solid, a plasma, or any combination thereof as a fuel source in a reaction volume; and
irradiating the fuel source with a photon beam, a direct electron beam, or both, to produce energetic electrons, wherein
the fuel source is in a liquid or solid state at room temperature, the fuel source is loaded cryogenically as a liquid, one or more high-Z materials capable of donating electrons and/or neutrons are provided in the reaction volume, materials capable of being fissioned or being fertile are provided in the reaction volume, materials capable of producing multiplication events are provided in the reaction volume, electric fields are provided in the reaction volume, magnetic fields are provided in the reaction volume, one or more materials to be transmuted are provided in the reaction volume, one or more materials to moderate and/or reflect back neutrons leaving the reaction volume are provided, or any combination thereof, and
the energetic electrons created by the irradiating of the fuel source and/or the one or more high-Z materials cause at least some nuclei of atoms of the fuel source to become deeply screened for a period of time and/or to become neutral nuclei, facilitating nuclear fusion.

2. The method of claim 1, wherein the energetic electrons have an energy of less than 3 MeV.

3. The method of claim 1, further comprising:
providing high density neutrons with a total energy of 3 MeV or less, wherein
interaction between the neutrons with the total energy of 3 MeV or less forms neutral nuclei, thereby facilitating nuclear reactions.

4. The method of claim 2, wherein when there are two reacting neutrons, one reacting neutron is at rest while the other reacting neutron has an energy of approximately 3 MeV.

5. The method of claim 2, wherein when there are two reacting neutrons, one of the reacting neutrons is at rest, and the other reacting neutron is produced at a desired energy level by a photodistintegration of a deuteron due caused by a photon beam corresponding to formation of the reacting neutron with the desired energy level.

6. The method of claim 2, wherein when there are two reacting neutrons, at least one of the reacting neutrons is produced by nuclear events.

7. The method of claim 1, wherein the one or more high-Z materials comprise a powder, nanoparticles, materials capable of donating electrons and neutrons to nuclear activation processes, or any combination thereof.

8. The method of claim 1, wherein the materials capable of producing multiplication events produce (n,2n) multiplication events, (n,3n) multiplication events, or both.

9. The method of claim 1, wherein the plasma comprises a glow discharge plasma, a hot plasma, a two-temperature plasma that is provided such that an ion temperature is colder than an electron temperature and the electron temperature is hotter than the ion temperature, or any combination thereof.

10. The method of claim 1, wherein the photon beam comprises X-rays, gamma rays, or both.

11. The method of claim 1, wherein the irradiating of the fuel source with the photon beam causes production of delocalized energetic electrons following a photoelectron process, a Compton process, an electron-positron pair production process, or any combination thereof.

12. The method of claim 1, wherein the fuel source comprises at least one deuterated metal.

13. The method of claim 1, wherein an energy of the energetic electrons is less than 2.2 MeV.

14. A method, comprising:
providing a sufficient density of one or more hydrogen isotopes in the form of deuterium and/or tritium gas, a deuterated or tritated liquid, a deuterated or tritated solid, a plasma, or any combination thereof, as a fuel source in a reaction volume; and
exposing the one or more hydrogen isotopes, a target, or both, in the reaction volume to photon radiation, a direct electron beam, or both, causing production of delocalized energetic electrons in close proximity to nuclei of the one or more hydrogen isotopes, causing at least some nuclei of the one or more hydrogen isotopes to become deeply screened for a period of time and/or to become neutral nuclei, thereby facilitating nuclear fusion.

15. The method of claim 14, wherein the fuel source is in a liquid or solid state at room temperature, or the fuel source is loaded cryogenically as a liquid.

16. The method of claim 14, further comprising:
providing one or more high-Z materials capable of donating electrons and/or neutrons in the reaction volume.

17. The method of claim 14, further comprising:
providing materials capable of being fissioned or being fertile in the reaction volume.

18. The method of claim 14, further comprising:
providing materials capable of producing multiplication events in the reaction volume.

19. The method of claim 14, further comprising:
providing electric fields, magnetic fields, or both, in the reaction volume.

20. The method of claim 14, further comprising:
providing one or more materials to moderate and/or reflect back neutrons leaving the reaction volume.

21. A method, comprising:
providing high density neutrons with a total energy of 3 MeV or less, wherein
interaction between the neutrons with the total energy of 3 MeV or less forms neutral versions of deuterium and/or tritium nuclei.

22. The method of claim 21, wherein when there are two reacting neutrons, one reacting neutron is at rest while the other reacting neutron has an energy of approximately 3 MeV.

23. The method of claim 21, wherein when there are two reacting neutrons, one of the reacting neutrons is at rest, and the other reacting neutron is produced at a desired energy level by a photodistintegration of a deuteron due caused by a photon beam corresponding to formation of the reacting neutron with the desired energy level.

24. The method of claim 21, wherein when there are two reacting neutrons, at least one of the reacting neutrons is produced by nuclear events.
